(19) United States
(12) Patent Application Publication
(10) Pub. No.: US 2011/0131234 A1
(43) Pub. Date: Jun. 2, 2011

(54) INFORMATION PROCESS SYSTEM, AND PROGRAM

(75) Inventors: Kosuke Sasai, Kobe-shi (JP); Youichi Kawakami, Osaka-shi (JP)

(73) Assignee: Konica Minolta Medical & Graphic, Inc., Hino-shi, Tokyo (JP)

(21) Appl. No.: 12/674,041

(22) PCT Filed: Aug. 20, 2007
(86) PCT No.: PCT/JP2007/066110

§ 371 Date: Feb. 18, 2010

(51) Int. Cl. G06F 17/30

(52) U.S. Cl. 707/769; 707/E17.014

(57) ABSTRACT

The present invention provides a technology to shorten the time required for a process extracting a portion of the information from a database including a large amount of information indicating each of element combinations. In order to accomplish the above object, an information process system includes a first database in which a large amount of combination information indicating combinations of a plurality of elements composed of one or more elements associated with each item is accumulated, a second database in which a portion of the combination information included in the first database is accumulated, an extracting unit extracting information corresponding to an extraction condition from the second database in accordance with the designation of the extraction condition including information specifying the second database by the user, and an output unit visually outputting a list of the information in which one or more elements are associated with each item, on the basis of the information extracted by the extracting unit.

### TECHNICAL FIELD

The present invention relates to an information process system.

### BACKGROUND ART

At present, in the medical field, inspecting equipment visualizing the body state of the patient with a small CCD camera, ultrasound, radiation, nuclear magnetic resonance, nuclear medicine, and the like, is markedly progressed. In the inspections using those inspecting equipment, physicians look at the obtained images to diagnose and record diagnosis by writing.

For instance, in the inspections using endoscope, ultrasound, simple X-ray, and the like, physicians in charge of diagnosing the patients (attending physicians) generally look at the obtained images to write remarks observations on medical charts. On the other hand, for instance, in the inspections using inspecting equipment in which advanced techniques such as computed tomography (CT), magnetic resonance imaging (MRI), positron emission tomography (PET) and the like are applied, technical radiologists interpret radiogram from the obtained images to write a report describing the result of the interpretation of radiogram and report to the attending physicians.

However, in any inspections, sophisticated and broad expertise is required for drawing remarks and diagnosis from the images. For instance, the combinations as shown in FIG. 23 (the combinations applied with circles) exist between the imaging means (modality) and the regions to be an object of the inspections, and the expertise is required for interpreting radiogram with respect to the images for each combination of the modality and the region.

More in detail, for instance, in order to write description indicating the result of the interpretation of radiogram such as description of characteristics of the images (characteristics description), description of remark (remark description), and description of characteristics of specific disorders (disorder characteristics description), expertise as shown in FIG. 24 is required.

Specifically, with respect to the characteristics description, the image (characteristics image) well representing the characteristics of the affected area is required to be extracted from a large number of images obtained with the inspecting equipment so as to determine the elements belonging to each item in the order of the items of the configuration such as “imaging parameter, region, characteristics, fundamental remark, conclusion”. Then, it is required to determine the element belonging to each item in the order of the items such as “diagnosis, conclusion” so as to describe the remark description. With respect to the disorder characteristics description, when a specific disorder (e.g. tumors) is discovered, it is required to determine the element belonging to each item in the order of the items such as “disorders, state of disorders, affected region, affection, conclusion”.

In FIG. 24, while the examples of the characteristics description, remark description, and disorder characteristics description are shown, the marks “/” are denoted for distinguishing the elements (terms, phrases, and clauses) belonging to each item from other elements. Also, the category corresponding to each description example (e.g. “angiopathy” and “infection, inflammation”) is shown.

As such, the sophisticated expertise and the ability to instantly express the determination result depending on its expertise are required for physicians interpreting radiogram.

However, it is difficult for the radiologists to be familiar with the past cases with respect to all the combinations of the modality and the region. Thus, it is desirable to reduce complexity on the input of the report.

A technology is proposed (for example, see Japanese Patent Application Laid-Open No. 2007-140859), the technology presenting a list offered by assembling a database so as to associate each element belonging to each item between each item relating to a plurality of items to which a plurality of elements composing a report belong, and by extracting a portion of the information corresponding to the extraction condition designated by a user. According to this technology, the user is able to create a report, using the knowledge in the past by referring to the list of information, supporting accurate and smooth creation of the report.

A technology is also proposed (for example, see Japanese Patent Application Laid-Open No. 2007-140859), the technology presenting the element combinations necessary for the characteristics description and the remark description on the basis of the past cases in accordance with the frequency of appearance of the past cases in the list of the information supporting the creation of the report, and creating a sentence in accordance with the selection of the elements to each item.

Further, a technology is also proposed (for example, see Japanese Patent Application Laid-Open No. 2007-140862), the technology allowing to select a prefix and a suffix according to the need for each element, and creating a sentence in accordance with the selection of more complex expressions.

In these proposed technologies, the elements and the element combination composing the database are added in accordance with the input of the radiological report on a new case, and its frequency is sometimes changed. Therefore, information supporting the input of the report is obtained from the database developing as time elapses.

However, in order to assemble the database in which information indicating the relation between the elements is accumulated as in the above and present the information supporting the input of the report in response to the input of the extraction condition by the user, it is necessary to extract and present information corresponding to a desired condition from the database composed of large amounts of data. Thus, there has been the problem that the process time required for extracting and presenting the information from the input of the extraction condition by the user is prolonged.

Further, as the elements composing the database (i.e. the amount of data) is increased in order to enrich the knowledge in the past, the operation amount required for the process extracting a portion of information from the database is increased, causing further prolonged process time.

### DISCLOSURE OF INVENTION

The present invention has been made in view of the above problem, and is intended to provide a technology shortening the time required for a process of extracting a portion of information from the database including a large amount of information indicating each element combination.

In order to solve the above problem, according to a first aspect of the information process system, the information process system includes: a first database in which a large amount of combination information indicating combinations of a plurality of elements composed of one or more elements associated with each item, is accumulated; a second database in which a portion of the combination information included in the first database is accumulated; an extracting unit extracting information corresponding to an extraction condition including information specifying the second database from the second database in accordance with designation of the extraction condition by a user; and an output unit visually outputting a list of information in which one or more elements is associated with each item, on the basis of information extracted by the extracting unit.

This limits the amount of data to be an object of search, so that the operation amount required for the process extracting a portion of information from the database is decreased. Therefore, the time required for the process extracting a portion of information from the database including a large amount of information indicating each element combination, is shortened.

According to a second aspect of the information process system, the information process system according to the first aspect, further includes an assembling unit extracting a portion of the combination information from the first database in accordance with the input by the user, and assembling a third database storing the portion of the combination information.

This assembles a lower database from relatively an upper database at a desired section appropriately. Particularly, when a stratification method of the lower database is changed, the user is allowed to easily stratify the lower database at a desired section.

According to a third aspect of the information process system, the information process system according to the first aspect further includes: a reception unit receiving input information indicating a combination of a plurality of elements composed of one or more elements associated with each item in response to the input by the user; and an update unit updating the first and second databases by adding the combination information indicating the combination of the plurality of elements composed of one or more elements associated with each item to each of the first and second databases on the basis of the input information.

This allows both of the upper and lower databases to be easily developed in accordance with the input of new knowledge. When the stratification method of the lower database is changed due to update of the upper database, the database is allowed to be easily stratified at a desired section, reflecting the new knowledge obtained as the time elapses.

According to a fourth aspect of the information process system, the information process system according to the third aspect, further includes: an acquiring unit acquiring report information in accordance with the input by the user; and a generating unit generating the input information by performing a predetermined information process including a language process with the report information as an object to recognize a plurality of elements composting the report information, and by associating information indicating items to which each element belongs, with each element composing the report information to combine the plurality of elements composing the report information.

This allows both of the upper and lower databases to be easily developed in accordance with the input of new report information.

According to a fifth aspect of the information process system, the information process system according to the first aspect, further includes: a designating unit designating at least one element to each item in accordance with the input by the user in the list of the information; and a generating unit generating report information in accordance with a predetermined model on the basis of a plurality of elements designated by the designating unit.

This allows to easily create a report.

According to a sixth aspect of the information process system, in the information process system according to the first aspect, the combination information includes information described in RDF.

This allows to easily describe the database.

According to a seventh aspect of the information process system, the information process system according to the first aspect further includes: a storage unit storing a plurality of report information; and an assembling unit assembling the first database by performing a predetermined information process including a language process with each of the report information as an object to recognize a plurality of elements composing each of the report information, and by associating information indicating items to which each element belongs, with each element composing each of the report information to combine the plurality of elements composing each of the report information.

This allows to easily assemble the database.

According to an eighth aspect of the information process system, in the information process system according to the first aspect, the combination information includes information indicating a combination of a plurality of elements relating to medical care.

According to a ninth aspect of the information process system, in the information process system according to the eighth aspect, the plurality of elements relating to the medical care includes a plurality of elements composing a radiological report.

According to a tenth aspect of the information process system, in the information process system according to the ninth aspect, at least either one of the first and second databases accumulates a plurality of combination information including one or more elements indicating at least either one of a specific region and a specific modality.

According to an eleventh aspect of the information process system, the information process system is allowed to function as the information process system according to the first to tenth aspects by being implemented with a computer included in the information process system.

### BRIEF DESCRIPTION OF DRAWINGS

FIG. 1 is a view schematically showing a configuration of an information process system according to a preferred embodiment of the invention.

FIG. 2 is a block diagram showing a functional configuration of the information process system.

FIG. 3 is a view illustrating structured report information.

FIG. 4 is a view illustrating data contents in a database.

FIG. 5 is a view illustrating another data contents in the database.

FIG. 6 is a view illustrating another data contents in the database.

FIG. 7 is a view illustrating a hierarchical structure of the database.

FIG. 8 is a view illustrating a screen presenting a main menu.

FIG. 9 is a view illustrating a screen setting stratification information.

FIG. 10 is a view illustrating a screen changing a setting of the stratification information.

FIG. 11 is a view illustrating a screen of a list of inspections.

FIG. 12 is a view illustrating a report input screen.

FIG. 13 is a view illustrating a request.

FIG. 14 is a view illustrating detailed contents of the inspection.

FIG. 15 is a view illustrating a list of frequently-appearing phrases.

FIG. 16 is a view illustrating a list of summarizing phrases.

FIG. 17 is a view illustrating an extraction condition determining template.

FIG. 18 is a view illustrating an input support template.

FIG. 19 is a flow chart showing an operation flow of the information process system.

FIG. 20 is another flow chart showing the operation flow of the information process system.

FIG. 21 is another flow chart showing the operation flow of the information process system.

FIG. 22 is another flow chart showing the operation flow of the information process system.

FIG. 23 is a view illustrating combinations of a region and a modality requiring expertise.

FIG. 24 is a view illustrating knowledge necessary for writing a sentence describing the result of the interpretation of radiogram.

### BEST MODE FOR CARRYING OUT THE INVENTION

### Overview of Information Process System

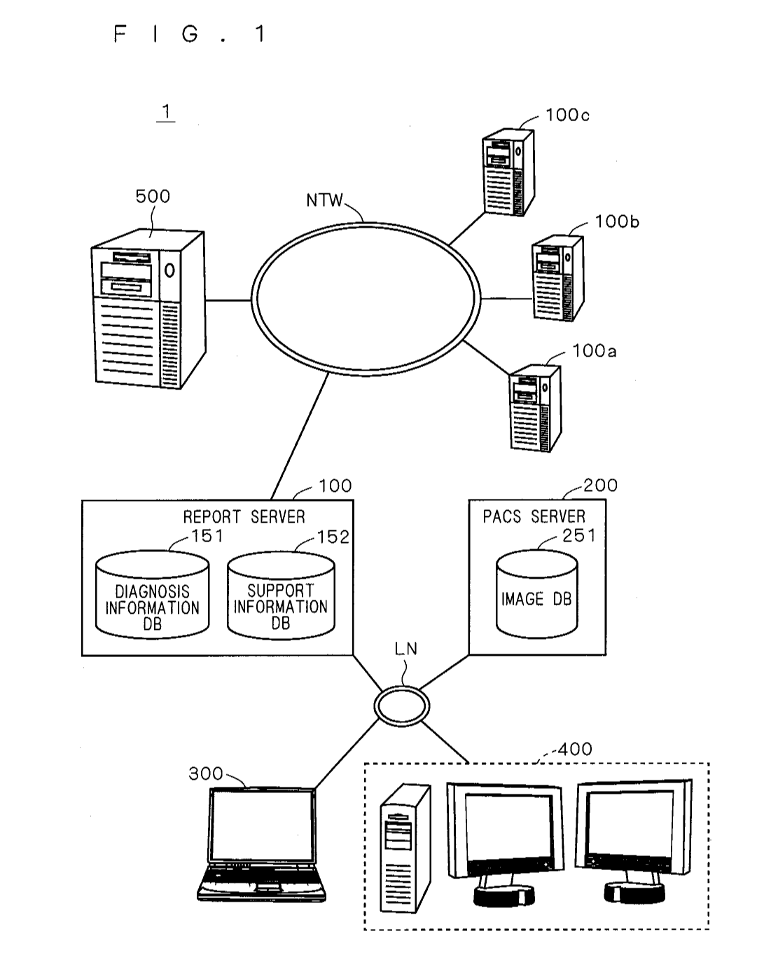

FIG. 1 is a view schematically showing a configuration of an information process system 1 of the present invention.

The information process system 1 is configured to include report servers 100, 100a to 100c, a picture archiving and communication system (PACS) server 200, a report input terminal (hereinafter, simply abbreviated as a “terminal”) 300, an image browsing terminal (hereinafter, simply abbreviated as a “terminal”) 400, and a data center server 500.

The report servers 100, 100a to 100c, and the data center server 500 are connected to one another to transmit/receive data via a network line NTW such as the Internet, for example. The report server 100, the PACS server 200, the terminal 300, and the terminal 400 are mounted in the same hospital, for example, and connected to one another to transmit/receive via a network line such as the LAN in the hospital. Each of the terminals 300 and 400 is, for example, composed of a personal computer (PC) and the like.

The report server 100 is, for example, composed of a personal computer (PC) or the like. This report server 100 stores a diagnosis information database (diagnosis information DB) 151, and a support information database (support information DB) 152 in a built-in storage unit.

The diagnosis information DB 151 is a database in which a large amount of medical information (hereinafter, also referred to as “diagnosis information”) on a number of patients to be objects of diagnosis is accumulated. This diagnosis information DB 151 includes, for example, information (inspection list information) indicating a list (hereinafter, also referred to as an “inspection list”) listing information on a number of inspections. The diagnosis information DB 151 also stores attribute information indicating information on patients, inspections, and requests from attending physicians so as to be associated with an inspection ID listed on the inspection list.

A large number of image data obtained by imaging those who are the objects of the inspections listed in the inspection list, i.e. the patients as the objects, with radiogram in a radiological department is stored in an image database (image DB) 251 stored in the PACS server 200. The report information indicating a radiological report corresponding to each of the large number of image data stored in the image DB 251 is stored in the diagnosis information DB 151 to be associated with the inspection ID listed in the inspection list. Here, focusing on the point that the large number of report information is stored, the diagnosis information DB 151 functions as a database (report DB) storing the large amount of report information.

The report server 100 generates a database (support information DB) 152, in which information (support information) supporting the creation and input of a new radiological report is accumulated, by using the report information (existing report information) already stored in the diagnosis information DB 151. The report server 100 appropriately extracts the support information from the support information DB 152 in response to the input of the information from the terminal 300 to provide to the terminal 300 in the form of a template.

Further, the report server 100 stores the report information indicating a new report in the diagnosis information DB 151 in accordance with the input of the new report information from the terminal 300.

Each of the report servers 100a to 100c is, for example, mounted in a different hospital from the hospital where the report server 100 is mounted. Since the report servers 100a to 100c have the similar configuration and function as the report server 100, the explanation is made with the report server 100 as a representative example, hereinafter.

A function generating the support information DB 152 (hereinafter, also referred to as an “information generating function”), and a function providing the support information from the support information DB 152 to the terminal 300 and inputting a radiological report (hereinafter, also referred to as a “report input function”), will be further described later.

The data center server 500 collects the data contents of each diagnosis information DB 151 and each support information DB 152 stored in each of the report servers 100, 100a to 100c, and appropriately provides the optimized information to the report servers 100, 100a to 100c. Thereby, for example, the findings obtained in a certain hospital are reflected to the support information DB 152 used in another hospital, allowing much broader knowledge in the past to be used.

The PACS server 200 is, for example, composed of a personal computer (PC) and the like. This PACS server 200 stores the image DB 251 in a built-in storage unit. The image DB 251 is, for example, a database in which a large amount of data (image data) indicating the image capturing the affected area obtained by a CT or an MRI is accumulated in a manner of being distinguishable for each inspection (e.g., inspection ID).

This PACS server 200 appropriately provides the image data stored in the image DB 251 with the terminal 400 in accordance with the input of the information from the terminal 300. The terminal 400 visually outputs the image data provided from the PACS server 200.

The terminal 300 inputs new report information in accordance with the input of information by the user (e.g. radiologists). When this new report information is inputted, the user visually identifies the image data visually outputted in the terminal 400 and displays a screen in accordance with the support information from the report server 100 in the terminal 300 to input the new report information.

<Functional Configuration>

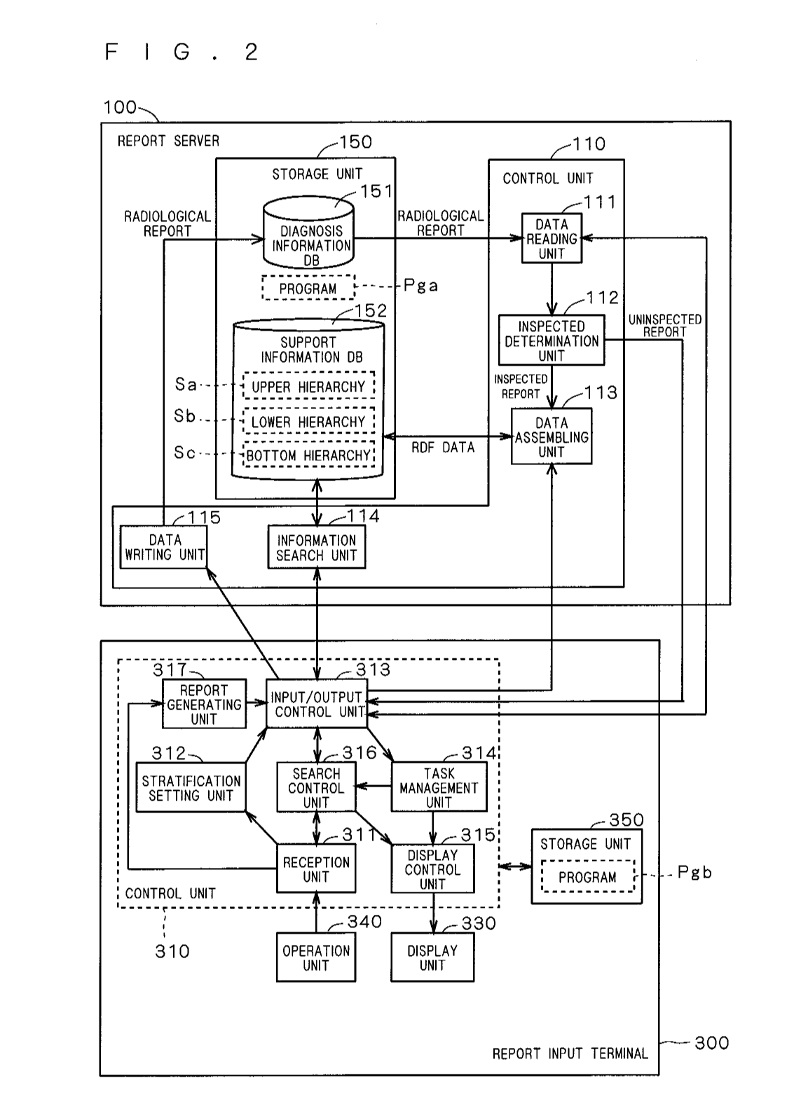

FIG. 2 is a block diagram showing a functional configuration relating to an information generating function and a report input function in the information process system 1. The information generating function and the report input function are mainly implemented in the report server 100 and the terminal 300, so that in FIG. 2, the functional configurations of the report server 100 and the terminal 300 are shown.

<Functional Configuration of Report Server 100>

The report server 100 mainly includes a control unit 110 and a storage unit 150.

The storage unit 150 is configured to include a hard disk and the like, and mainly stores the diagnosis information DB 151, the support information DB 152, a program Pga, and other data. The support information DB 152 is assembled on the basis of the report information accumulated in the diagnosis information DB 151. The other data includes, for example, file information (setting file) and the like, with which each screen generating rule is associated with respect to each form (search form) of the search rule.

The search rule is a rule requiring to obtain information from the support information DB 152, and the search form indicates which information is to be an object of the search and on which matters the information is to be obtained. This search rule may obtain a portion of information from given information by inferring, and for example, the information may be accumulated in the support information DB 152 by using a known resource description framework (RDF) and the inference supported by a known “Jena” which is a framework for building a known semantic web applications in the search rule, may be employed.

The screen generating rule is a rule generating a screen (result display screen) visually presenting a portion of the obtained information, and defining, for example, the number and the kind of items to be objects of presentation, the order of the items to be presented, and the arrangement of display elements and the like.

The control unit 110 is configured to mainly include a CPU, a RAM, a ROM and the like, and integrally controls each operation and function of the report server 100. This control unit 110 implements various functions relating to the information generating function and the report input function by reading and executing the program Pga stored in the storage unit 150.

Specifically, as shown in FIG. 2, in the control unit 110, a data reading unit 111, an inspected determination unit 112, a data assembling unit 113, an information search unit 114, and a data writing unit 115 are implemented. Various data temporarily generated in the control unit 110 is temporarily stored in the RAM in the control unit 110.

The data reading unit 111 reads radiological report information, attribute information corresponding to that radiological report information (e.g. requests, patient attributes, and information relating to the inspection attributes), and inspection list information from the diagnosis information DB 151. Then, the data reading unit 111 sends out the radiological report information, the attribute information and the inspection list information to the inspected determination unit 112 when generating the support information and supporting the input of the radiological report information. Further, the data reading unit 111 sends out the inspection list information to the terminal 300 when specifying the inspection (input object inspection) to be the object of the input of the radiological report information.

The inspected determination unit 112 determines whether the radiological report is created or not by writing the remarks to be included in the radiological report on each inspection, by referring to the inspection list information. Then, the inspected determination unit 112 sends out the generated (i.e. inspected) radiological report information to the data assembling unit 113 with the attribute information when generating the support information. Further, the inspected determination unit 112 sends out the incomplete (i.e. uninspected) radiological report information to the terminal 300 with the attribute information when supporting the input of the radiological report information.

The data assembling unit 113 extracts the necessary elements from the remarks described in a natural language included in the radiological report with a plurality of radiological report information as the object, and at the same time, extracts various elements included in the attribute information, structurizing by using the RDF to generate the support information.

In detail, first, the data assembling unit 113 generates information (hereinafter, also referred to as “combination information”) indicating the combination of a plurality of elements composed of one or more elements associated with each item included in the plurality of element items composing the remarks with respect to each radiological report information. At this time, the data assembling unit 113 assembles the database of an upper hierarchy Sa in the support information DB 152 by accumulating the plurality of the combination information relating to the plurality of the radiological report information.

Next, the data assembling unit 113 extracts a portion of the combination information included in the database of the upper hierarchy Sa in accordance with stratification information (later described) inputted from the terminal 300 to accumulate in the storage unit 150, thereby assembling the database of a lower hierarchy Sb in the support information DB 152.

Further, the data assembling unit 113 extracts a portion of the combination information included in the database of the lower hierarchy Sb in accordance with the stratification information inputted from the terminal 300 to accumulate in the storage unit 150, thereby assembling the database of a bottom hierarchy Sc in the support information DB 152.

That is, the database belonging to the upper hierarchy Sa in the support information DB 152 is configured by accumulating the large amount of the combination information. The database belonging to the lower hierarchy Sb in the support information DB 152 is configured by accumulating a portion of the combination information included in the database belonging to the upper hierarchy Sa. Further, the database belonging to the bottom hierarchy Sc in the support information DB 152 is configured by accumulating a portion of the combination information included in the database belonging to the lower hierarchy Sb.

In other words, the support information DB 152 is different from the database in which the items simply have the hierarchical structure, but has the form of the database (hierarchical database) where databases, in which substantive data contents (here, referring to the combination information) are accumulated, are hierarchically assembled.

The “stratification information” referred to here is information indicating from which database belonging to which hierarchy information is extracted at which section so as to assemble the database. A concrete example of the stratification information includes information such as assembling the database belonging to the lower hierarchy Sb for a kind of a desired category (e.g. angiopathy, infection, and inflammation) from the database in which the large amount of the combination information relating to a desired inspection region (e.g. brain, chest, and the like) and a modality (e.g. MR, and CT). An inspection region is a region to be the object of the inspection.

In this manner, the lower database relating to a desired section and concept is appropriately assembled from the relatively upper database.

The data assembling unit 113 appropriately extracts a portion of the combination information included in the database belonging to the upper hierarchy Sa in accordance with the input of new stratification information from the terminal 300 by the user, and assembles the database belonging to the lower hierarchy Sb storing this portion of the combination information to be included in the support information DB 152.

Further, the data assembling unit 113 appropriately extracts a portion of the combination information included in the database belonging to the lower hierarchy Sb in accordance with the input of the new stratification information from the terminal 300 by the user, and assembles the database belonging to the bottom hierarchy Sc storing this portion of the combination information to be included in the support information DB 152. That is, the data assembling unit 113 appropriately changes and reinforces the hierarchical structure of the support information DB 152 in accordance with the input of the information by the user.

The information search unit 114 extracts a portion of the combination information corresponding to a search rule from the support information DB 152 in response to the input of the search rule from the terminal 300 by the user. The search rule includes a condition (extraction condition) for extracting a portion of the combination information from the support information DB 152. This extraction condition includes, for example, information specifying the database of the lower hierarchy Sb in the support information DB 152 such as an inspection region and a modality, and further includes information specifying the database of the lower hierarchy Sc in the support information DB 152 such as a category.

The information search unit 114 generates information in which one or more elements are associated with each item on the basis of the extracted portion of the combination information and a screen generating rule corresponding to the search rule to generate display data (result display screen data) showing a screen (result display screen) displaying the search result. This result display screen data is sent out to the terminal 300, and in the terminal 300, the result display screen on the basis of the result display screen data is displayed on a display unit 330.

The data writing unit 115 adds the radiological report information generated in a report generating unit 317 (described later) to the diagnosis information DB 151.

<Functional Configuration of Terminal 300>

The terminal 300 mainly includes a control unit 310, a display unit 330, an operation unit 340, and a storage unit 350.

The storage unit 350 is configured to include a hard disk, and mainly stores a program Pgb, and other data.

The display unit 330 is composed of, for example, a liquid crystal display, a CRT, and the like to visually output various image data under the control of the control unit 310.

The operation unit 340 includes such as a keyboard and a mouse to send out various signals to the control unit 310 in response to the operation by the user.

The control unit 310 is configured to mainly include a CPU, a RAM, a ROM, and the like to integrally control various operations and functions of the terminal 300. This control unit 310 implements various functions relating to the information generating function and the report input function by reading and executing the program Pgb stored in the storage unit 350.

Specifically, as shown in FIG. 2, a reception unit 311, a stratification setting unit 312, an input/output control unit 313, a task management unit 314, a display control unit 315, a search control unit 316, and a report generating unit 317 are implemented. Various data temporarily generated in the control unit 310 is temporarily stored in the RAM and the like in the control unit 310.

The reception unit 311 is to receive the input of signals from the operation unit 340.

The stratification setting unit 312 is to set the stratification information in accordance with the signals inputted from the operation unit 340 via the reception unit 311. This stratification setting unit 312 sends out the set stratification information to the report server 100 (specifically, data assembling unit 113) via the input/output control unit 313.

The input/output control unit 313 is to control transmission/reception of data between the terminal 300 and external devices of the terminal 300 (e.g. the report server 100 and the like).

The task management unit 314 is to specify the task relating to the creation of a new radiological report corresponding to an input object inspection in accordance with the selection of an inspection (input object inspection) to be the input object of the new radiological report.

The display control unit 315 is to control the visual output of various image data in the display unit 330. Specifically, on the basis of various information inputted from the report server 100, various screens are displayed in the display unit 330. For instance, on the basis of the result display screen data inputted from the information search unit 114, the result display screen is displayed in the display unit 330.

The search control unit 316 is to control the search of information with the support information DB 152 as the object in cooperation with the report server 100. Specifically, in accordance with the input of the signal from the operation unit 340 by the user, the search rule is generated and sent out to the report server 100 (specifically, the information search unit 114) via the input/output control unit 313. The search control unit 316 receives the result display screen data generated in the information search unit 114 via the input/output control unit 313, and at the same time, transfers to the display control unit 315.

When new report information is inputted, in accordance with the input of the signal from the operation unit 340 by the user, the report generating unit 317 receives the new report information (structured report information) in the form of data (structured data) with which a plurality of elements are associated, and generates new radiological report information in accordance with a predetermined rule, on the basis of the structured report information.

Hereinafter, referring to FIG. 2, the information generating function and the report input function will be further described.

<Information Generating Function>

First, the data reading unit 111 reads the radiological report information, the attribute information corresponding to this radiological report information, and inspection list information to send out to the inspected determination unit 112.

Next, the inspected determination unit 112 determines whether the radiological report is generated or not for each inspection, by referring to the inspection list information, and send out the generated radiological report information to the data assembling unit 113 together with the attribute information.

Then, the data assembling unit 113 extracts various elements included in the attribute information, in addition to extract necessary elements from the remarks included in the radiological report, to structurize by using the RDF. The structurization of this radiological report element is carried out, for example, by using machine learning.

Here, the function of the data assembling unit 113, specifically, the function of the machine learning (machine learning function), the function of identifying elements (identifying function), and the function of structurizing the radiological report (structurizing function) by associating the identified elements, will be described.

When a learning corpus and the like are given as teaching data by the machine learning function of the data assembling unit 113, information to be the standard of the structurization is learned.

The learning corpus includes a large amount of text data according to the format of the remark included in the radiological report (specifically, sentence model). This sentence model expresses the configuration of the remark like imaging parameter→region→fundamental remark (characteristics−conclusion)→diagnosis (diagnosis−conclusion).

In detail, in the learning corpus, the name of classification item (hereinafter, appropriately abbreviated as an “item”) of each element composing the sentence model of the remark is tagged with each word and/or phrase. The names (item name) of the items of the elements are, for example, “imaging parameter”, “region”, “fundamental remark”, “diagnosis”, and the like.

Specifically, the words and/or phrases such as “front image”, “side image”, and the like are tagged with the item name of the element “image parameter”, and the words and/or phrases such as “upper lung field”, “middle lung field”, and the like are tagged with the item name of the element “region”. The words and/or phrases such as “consolidation”, “linear opacity”, and the like are tagged with the item name of the element “fundamental remark”, and the words and/or phrases such as “lung cancer”, “pulmonary emphysema”, and the like are tagged with the item name of the element “diagnosis”.

When the learning corpus is given from the outside to the data assembling unit 313, data indicating a representative sentence model (sentence model) specifying the conclusion to some extent is given from the outside.

The machine learning function of the data assembling unit 113 extracts the words and/or phrases from the learning corpus to store in each item of the corresponding element. Here, the data learned and stored is used as data (model data) indicating to which element item each element composing a radiological report is classified.

Next, the identifying function of the data assembling unit 113 identifies the element item and the words and/or phrases actually used with the above model data as a reference and with the radiological report information inputted to the data assembling unit 113 as the object.

For instance, the machine learning using a so-called support vector machine (SVM) may identify the element item with respect to the elements which are previously not given in the teaching data. In detail, the machine learning function of the data assembling unit 113 disassembles the learning corpus into morpheme by the morphological analysis to learn a pattern (appearance pattern), morpheme by morpheme, in which a morpheme belonging to a certain item appears, by using information such as the morpheme itself, the word class of the morpheme, conjugate of the morpheme, and information of the morphemes on the front and back sides (for example, two morphemes each on the front and back sides), and the element item may be identified by using this appearance pattern.

Further, the structurizing function of the data assembling unit 113 structurizes elements composing the remark by disassembling various information included in the radiological report information and the attribute information into the words and/or phrases (elements) belonging to each element item on the basis of the information identified by the identifying function, and then describing in the RDF.

The data (hereinafter, also referred to as “single-report structured data”) described in the RDF, in which elements composing one radiological report are structurized by adding the attribute information on the radiological report and the elements composing the attribute information of an inspection and a patient, is assembled. Here, with respect to each element composing each radiological report information, information indicating the element item to which each element belongs is provided as the attribute information.

That is, the single-report structured data is data in which one or more elements belonging to each item is associated with each item, and corresponds to information in which a plurality of elements are combined, that is, a single piece of combination information.

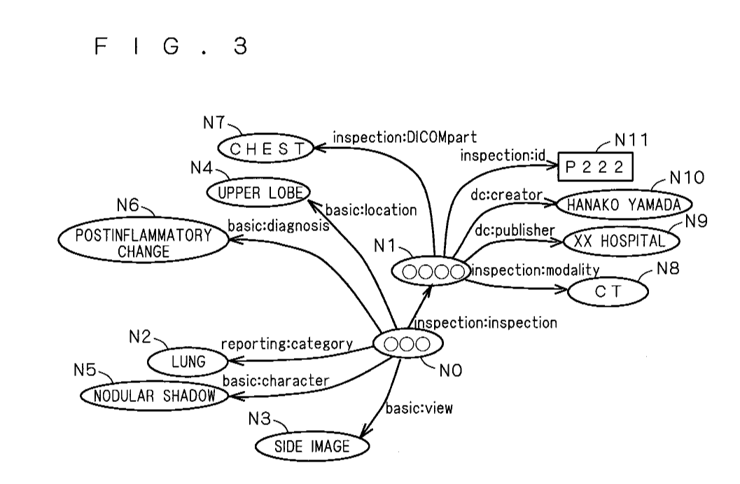

FIG. 3 is a schematic diagram illustrating a concrete example, i.e. a configuration example of the single-report structured data.

As shown in FIG. 3, the single-report structured data is configured by linking a plurality of nodes (ellipse, and rectangle in Figure) in which the elements (specifically, an attribute value and the like) are described, with arc (arrows in Figure) showing the item name (specifically, attribute).

In the single-report structured data as shown in FIG. 3, the plurality of nodes N1 to N11 are linked with a plurality of arcs with a node N0 showing a report as a starting point.

The attribute shown by each arc linked to the nodes N1 to N11 include, for example, an inspection (inspection:inspection), a category (reporting:category), an imaging parameter (basic:view), a region (basic:location), a remark (basic:character), diagnosis (basic:diagnosis), inspected region (inspection:DICOMpart), a modality (inspection:modality), a hospital name (dc:publisher), a radiologist (dc:creator), and an inspection ID (inspection:id). The inspected region (inspection:DICOMpart) is a so-called an inspected region of a DICOM attribute.

In FIG. 3, and the rest of the Figures after FIG. 3, desired contents are appropriately described in the node N0 and N1, reciting “o o o”, “o o o o”. The elements described in each of the nodes N0 to N11 are not limited to what are shown in FIG. 3, but may include other elements. Further, the attributes are not limited to what are shown in FIG. 3, but may include other attributes. Other attributes are, for example, prefix, suffix, and the like.

From the machine learning function, the identifying function, and the structurizing function of the data assembling unit 113 as described above, the single-report structured data as shown in FIG. 3 is generated for each of the large amount of inspected radiological report information stored in the diagnosis information DB 151. Then, the large amount of the generated single-report structured data is accumulated in the storage unit 150.

At this time, with respect to a predetermined attribute in the plurality of the single-report structured data, the database belonging to the upper hierarchy Sa in the support information DB 152 is generated, sharing a common attribute value.

In this manner, the database belonging to the upper hierarchy Sa is assembled by a predetermined information process including a language processing with the plurality of report information stored in the diagnosis information DB 151 as the object. Therefore, the support information DB 152 is easily assembled.

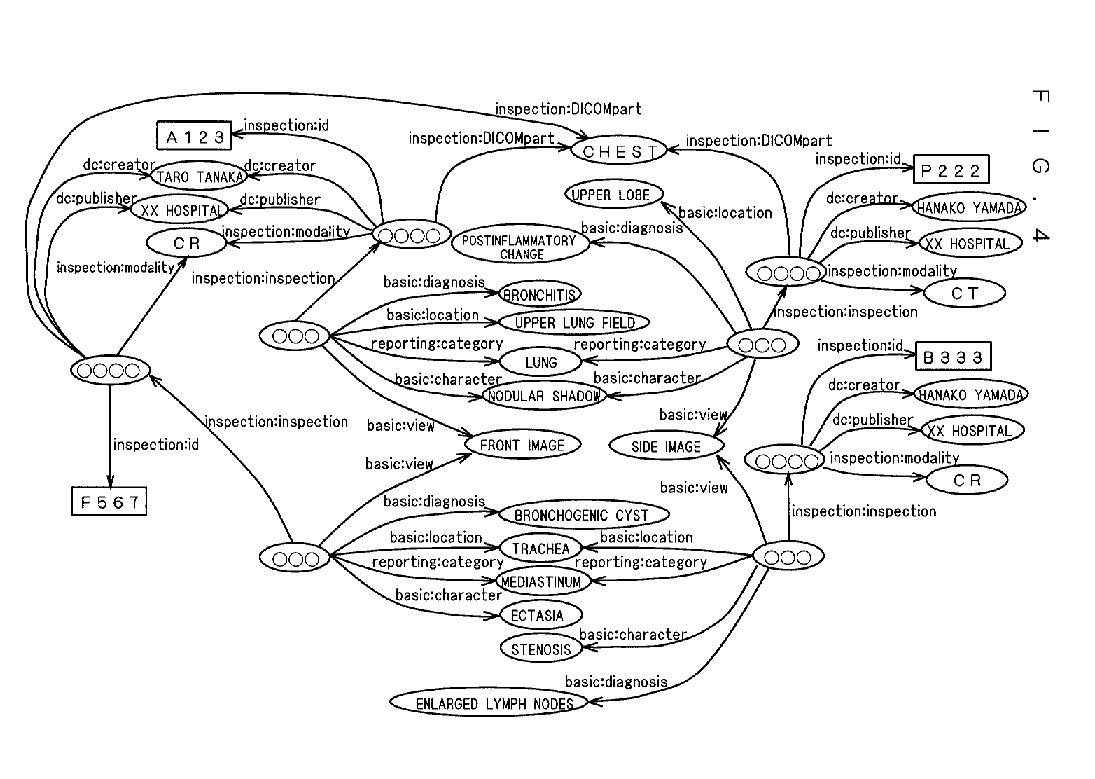

FIG. 4 is a view illustrating data contents of the database belonging to the upper hierarchy Sa. In FIG. 4, with respect to four pieces of the single-report structured data, a mass of structured data assembled by sharing the common attribute value is shown. In FIG. 4, for reasons of the Figure, the structured data assembled on the basis of the four pieces of the single-report structured data is shown, but in reality, the structured data is assembled on the basis of the large amount of the single-report structured data.

Next, the construction of the database belonging the lower hierarchy Sb and the bottom hierarchy Sc will be described.

The data assembling unit 113 has a function (stratification function) of extracting a portion of the combination information in accordance with the stratification information from the database belonging to the upper hierarchy Sa to construct the database belonging to the lower hierarchy Sb, and extracting a portion of the combination information in accordance with the stratification information from the database belonging to the lower hierarchy Sb to construct the database belonging to the bottom hierarchy Sc.

FIG. 5 is a view illustrating data contents of the database belonging to the lower hierarchy Sb composed of a portion of the combination information included in the database belonging to the upper hierarchy Sa shown in FIG. 4.

FIG. 5 shows the combination information satisfying the condition that the attribute value of the attribute “inspection region” is “CHEST” and the attribute value of the attribute “modality” is “CR”, in the database belonging to the upper hierarchy Sa shown in FIG. 4. That is, FIG. 5 shows the combination information included in the single-report structured data satisfying the condition that the attribute value of the attribute “inspection region” is “CHEST” and the attribute value of the attribute “modality” is “CR”, in the plurality of the single-report structured data composing the database belonging to the upper hierarchy Sa. In detail, the database belonging to the lower hierarchy Sb is configured by extracting data (combination information) relating to five attributes “category”, “imaging parameter”, “region”, “fundamental remark”, and “diagnosis” from each of the single-report structured data.

At this time, the stratification information includes information indicating to extract the combination information relating to the five attributes “category”, “imaging parameter”, “region”, “fundamental remark”, and “diagnosis” from the single-report structured data satisfying the condition that the attribute value of the attribute “inspection region” is “CHEST” and the attribute value of the attribute “modality” is “CR”.

Here, a portion of the combination information composing three pieces of the single-report structured data is extracted from the four pieces of the single-report structured data shown in FIG. 4, but not being limited to this, one or more pieces of the combination information composing the large amount of the single-report structured data may be extracted.

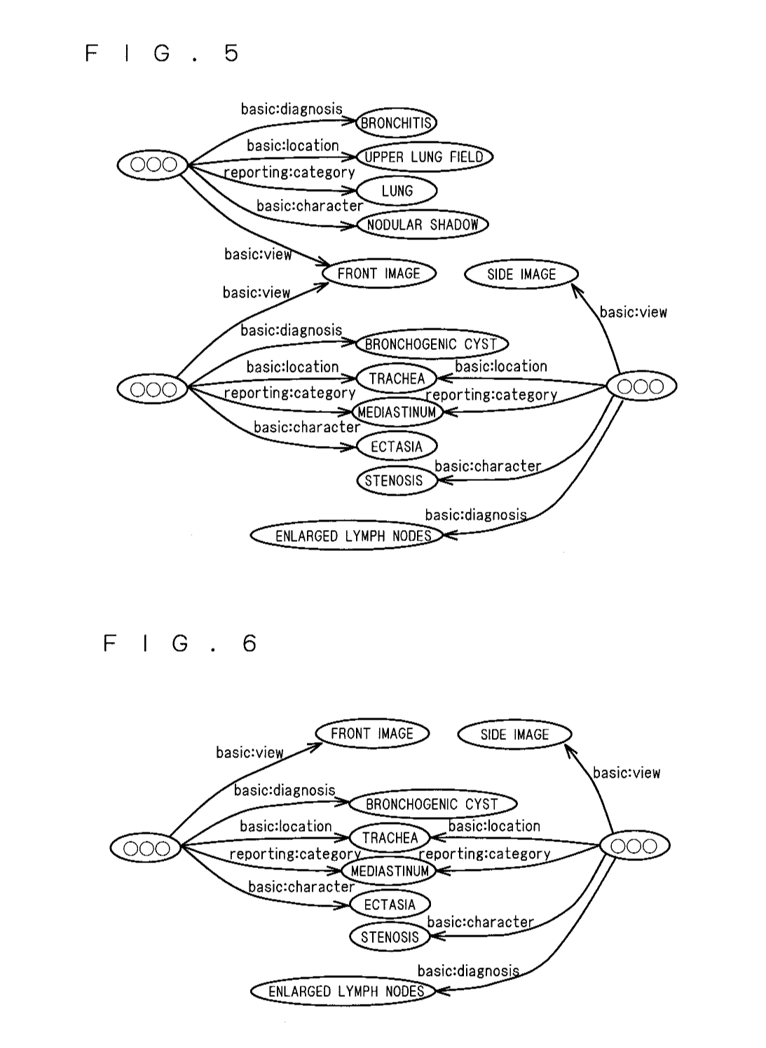

FIG. 6 is a view illustrating data contents of the database belonging to the bottom hierarchy Sc composed of a portion of the combination information included in the database belonging to the lower hierarchy Sb shown in FIG. 5.

FIG. 6 shows the combination information satisfying the condition that the attribute value of the attribute “category” is “mediastinum”, in the database belonging to the lower hierarchy Sb shown in FIG. 5. That is, FIG. 6 shows the combination information included in the single-report structured data satisfying the condition that the attribute value of the attribute “category” is “mediastinum”, in the plurality of the single-report structured data composing the database belonging to the lower hierarchy Sb shown in FIG. 5. In detail, the database belonging to the bottom hierarchy Sc is configured by extracting data (combination information) relating to the five attributes “category”, “imaging parameter”, “region”, “fundamental remark”, and “diagnosis”, from each of the single-report structured data.

At this time, the stratification information includes information indicating to extract the combination information relating to the five attributes “category”, “imaging parameter”, “region”, “fundamental remark”, and “diagnosis” for the single-report structured data satisfying the condition that the attribute value of the attribute “category” is “mediastinum”, from the database satisfying the condition that the attribute value of the attribute “inspection region” is “CHEST” and the attribute value of the attribute “modality” is “CR”, in the database belonging to the lower hierarchy Sb.

Here, a portion of the combination information composing two pieces of the single-report structured data shown in FIG. 6 is extracted from the three pieces of the single-report structured data shown in FIG. 5, but not being limited to this, one or more pieces of the combination information composing the large amount of the single-report structured data may be extracted.

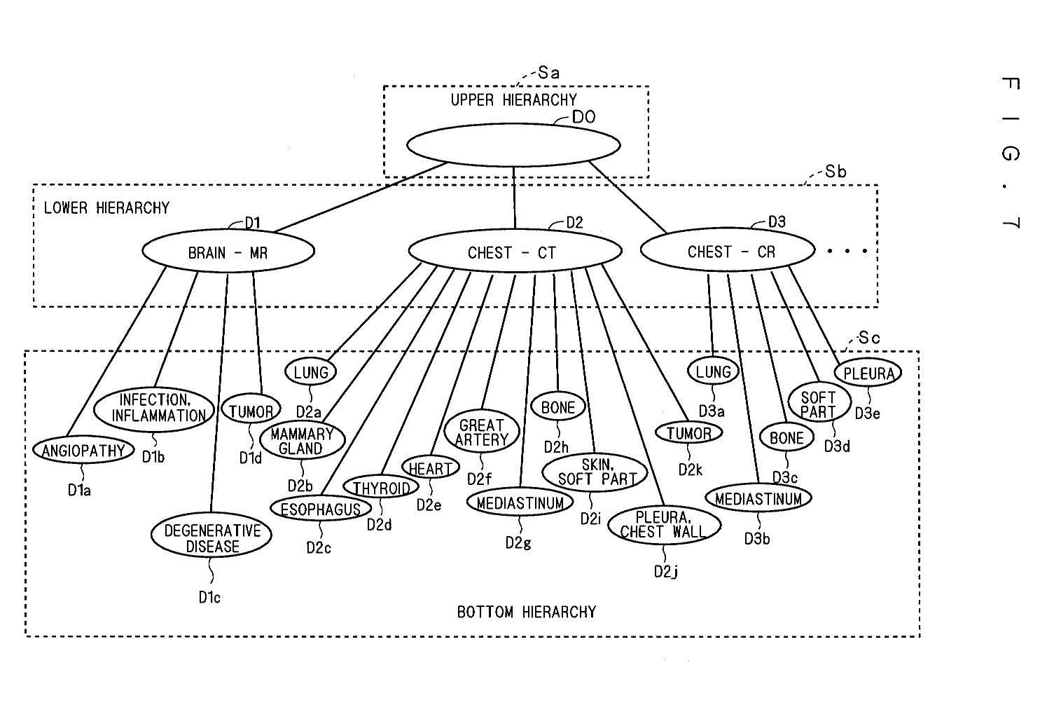

FIG. 7 is a view illustrating the data contents composing the support information DB 152, i.e. the hierarchical structure of the database.

As shown in FIG. 7, the support information DB 152 has the three-staged hierarchical structure of the upper hierarchy Sa, the lower hierarchy Sb, and the bottom hierarchy Sc.

The upper hierarchy Sa includes a database D0 composed of the large amount of the single-report structured data.

The lower hierarchy Sb includes databases D1 to D3, each of which is configured by extracting a portion of the combination information from the database D0 belonging to the upper hierarchy Sa. In FIG. 7, each of the databases D1 to D3 and the database D0, which is where the plurality of the combination information composing each of the databases D1 to D3 is extracted, are connected to each other with a straight line.

FIG. 7 illustrates the condition satisfied by the plurality of the combination information composting each of the databases D1 to D3, i.e. the combination of the attribute value of the attribute “inspection region” and the attribute value of the attribute “modality”. Specifically, the database D1 is composed of the plurality of the combination information relating to the combination of the attribute values of “brain” and “MR”, and the database D2 is composed of the plurality of the combination information relating to the combination of the attribute values of “chest” and “CT”. The database D3 is composed of the plurality of the combination information relating to the combination of the attribute values of “chest” and “CR”.

The bottom hierarchy Sc includes databases D1a to D1d, D2a to D2k, and D3a to D3e, each of which is configured by extracting a portion of the combination information from each of the databases D1 to D3 belonging to the lower hierarchy Sb.

In FIG. 7, each of the databases D1a to D1d, D2a to D2k, and D3a to D3e and each of the databases D1 to D3, which is where one or more pieces of the combination information composing each of the databases D1a to D1d, D2a to D2k, and D3a to D3e is extracted, are connected to each other with a straight line.

Specifically, where one or more pieces of the combination information composing each of the databases D1a to D1d is extracted is the database D1, and where one or more pieces of the combination information composing each of the databases D2a to D2k is extracted is the database D2. Where one or more pieces of the combination information composing each of the databases D3a to D3e is extracted is the database D3.

FIG. 7 illustrates the condition satisfied by the one or more pieces of the combination information composing each of the databases D1a to D1d, D2a to D2k, and D3a to D3e, i.e. the attribute value of the attribute “category”. For instance, the database D1a is composed of one or more pieces of the combination information relating to the attribute value “angiopathy”.

That is, one or more pieces of the combination information relating to each of the attribute values such as “angiopathy”, “infection, inflammation”, “degenerative disease”, and “tumor” is extracted from the database D1 to compose each of the databases D1a to D1d. From the database D2, one or more pieces of the combination information relating to each of the attribute values such as “lung”, “mammary gland”, “esophagus”, “thyroid”, “heart”, “great artery”, “mediastinum”, “bone”, “skin, soft part”, “pleura, chest wall”, and “tumor” is extracted to compose each of the databases D2a to D2e. From the database D3, one or more pieces of the combination information relating to each of the attribute values such as “lung”, “mediastinum”, “bone”, “soft part”, and “pleura” is extracted to compose each of the databases D3a to D3e.

Here, the input of the stratification information in the terminal 300 will be described.

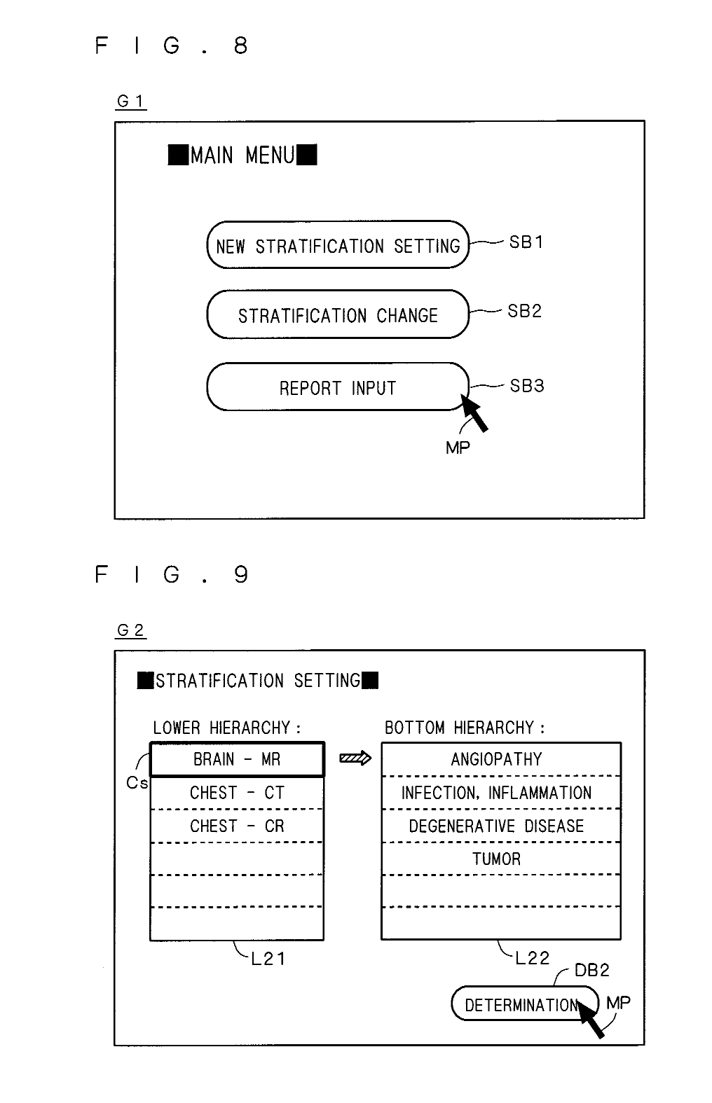

FIG. 8 is a view illustrating a main menu screen G1 displayed in the terminal 300 when the information process system 1 is used. Here, the user appropriately operates the operation unit 340 in the terminal 300 to display the main menu screen G1 in the display unit 330.

The main menu screen G1 is a screen in which a plurality of functions executable in the information process system 1 are presented and a desired function is selected from those plurality of functions. Specifically, the main menu screen G1 presents buttons SB1 to SB3 on each of which the names of the three functions of “new setting of stratification”, “stratification change”, and “report input” are recited, respectively.

The user operates the operation unit 340 in various ways to select any one of the three functions of “new setting of stratification”, “stratification change”, and “report input” by pushing down any one of the buttons SB1 to SB3 with a mouse pointer MP. For instance, when the buttons SB1 and SB2 are pushed down, the operation relating to the information generating function is executed, and when the button SB3 is pushed down, the operation relating to the report input function is executed.

However, when the support information DB 152 has been already constructed, the setting of the stratification information has been already performed, so that the button SB1 is prohibited from being pushed down. On the other hand, when the support information DB 152 has not been constructed yet, the setting of the stratification information have not been performed yet, so that the button SB1 is allowed to be pushed down.

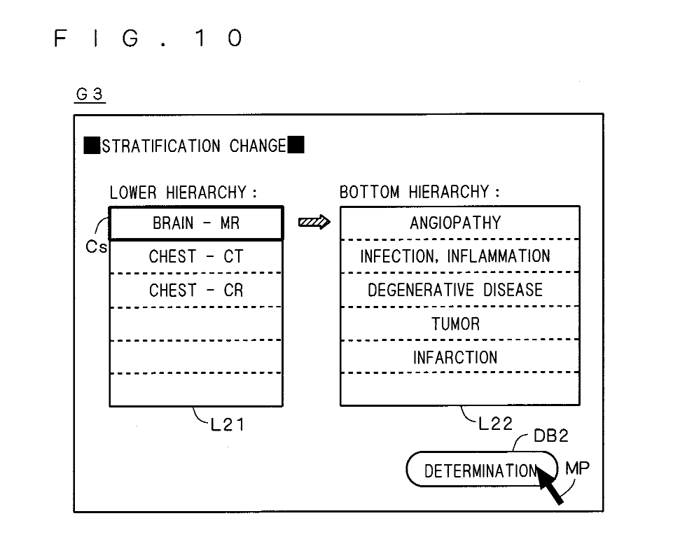

FIG. 9 is a view illustrating a screen (stratification setting screen) G2 for setting the stratification information. Here, when the button SB1 is pushed down in the main menu screen G1, the stratification setting screen G2 for newly setting the stratification information is displayed in the display unit 330.

The stratification setting screen G2 is a screen for setting the stratification information for assembling the database belonging to the lower hierarchy Sb and the stratification information for assembling the database belonging to the bottom hierarchy Sc.

In detail, the stratification setting screen G2 is allowed to set the stratification information indicating the condition satisfied by one or more pieces of the combination information composing each of the databases belonging to the lower hierarchy Sb (e.g. the combination of the attribute value of the attribute “inspection region” and the attribute value of the attribute “modality”), and the condition satisfied by one or more pieces of the combination information composing each of the databases belonging to the bottom hierarchy Sc (e.g. the attribute value of the attribute “category”).

Specifically, as shown in FIG. 9, the stratification setting screen G2 is provided with a space (column) L21 for describing the stratification information relating to the lower hierarchy Sb on the left side, and a space (column) L22 for describing the stratification information relating to the bottom hierarchy Sc on the right side. As a method of describing in the columns L21 and L22, for example, there is the method of pointing the mouse pointer MP to a desired line in the columns L21 and L22 to produce a cursor by pushing down (left click) a left button of the mouse and to appropriately input the text information from a keyboard.

For instance, the user operates the operation unit 340 in various ways to describe the combination of the attribute value of the attribute “inspection region” (e.g. brain, chest, and the like) and the attribute value of the attribute “modality” (e.g. MR, CT, CR, and the like) in each line of the column L21. FIG. 9 illustrates the state where the description “brain-MR” indicating the combination of “brain” and “MR”, the description “chest-CT” indicating the combination of “chest” and “CT”, and the description “chest-CR” indicating the combination of “chest” and “CR” are described in the column L21.

Also, for instance, the user operates the operation unit 340 in various ways, allowing to describe the attribute value defining the stratification information of the bottom hierarchy Sc by pointing a bold cursor Cs to a desired line in the column L21, for the combination of the attribute value (i.e. element) pointed by the bold cursor Cs.

For instance, the user operates the operation unit 340 in various ways to describe the attribute value of the attribute “category” (e.g. angiopathy) on each line in the column L22. FIG. 9 illustrates the state where the elements “angiopathy”, “inflation, inflammation”, “degenerative disease”, and “tumor” defining the stratification information relating to the bottom hierarchy Sc are described for the element combination “brain-MR” defining the stratification information relating to the lower hierarchy Sb.

While not shown, the elements defining the stratification information relating to the bottom hierarchy Sc corresponding to each of the element combinations “chest-CT”, “chest-CR” defining the stratification information relating to the lower hierarchy Sb may be described by the similar procedure.

When a determination button DB2 is pushed down with the mouse pointer MP in the state where the element combination and the element defining the desired stratification information are described on the columns L21 and L22, the stratification information is set. This set stratification information is appropriately stored in the storage unit 150 and the like.

FIG. 10 is a view illustrating a screen (stratification change screen) G3 for changing the setting of the stratification information. Here, when a button SB2 is pushed down in the main menu screen G1, the stratification change screen G3 for changing the setting of the stratification information is displayed in the display unit 330.

Since the stratification change screen G3 has the almost same configuration as the stratification setting screen G2 shown in FIG. 9, the same reference symbols are denoted for the same parts as the stratification setting screen G2, omitting the explanation thereof. That is, in the stratification change screen G3, by the same procedure as the stratification setting screen G2, the element combination and the element defining the desired stratification information are described on the columns L21 and L22.

In detail, in the stratification change screen G3, first, the element combination and the element defining the stratification information already set are displayed on the columns L21 and L22. Then, in accordance with the operation of the operation unit 340 by the user, the element combination and the element defining further new stratification information are supplementary described on the columns L21 and L22, and the element combination defining the stratification information listed on the columns L21 and L22 and the elements are appropriately deleted.

FIG. 10 illustrates the state where the element “infarction” defining the stratification information relating to the bottom hierarchy Sc is added for the element combination “brain-MR” defining the stratification information relating to the lower hierarchy Sb, comparing to the stratification setting screen G2 in FIG. 9.

Then, when the determination button DB2 is pushed down with the mouse pointer MP in the state where the element combination and the element defining the desired stratification information are described on the columns L21 and L22, the setting of the stratification information is changed. The setting of the stratification information having been changed is appropriately stored in the storage unit 150 and the like.

When a part of the element combination and the element defining the stratification information is deleted by changing the setting of the stratification information, the database corresponding to the element combination and the element having been deleted is removed from the support information DB 152. On the other hand, when new element combination and new element are added to the element combination and the element defining the stratification information by changing the setting of the stratification information, the database corresponding to the element combination and the element having been added is generated by the similar operation as the generation of the database belonging to the lower hierarchy Sb and the bottom hierarchy Sc described above so as to appropriately add to the support information DB 152.

When new radiological report information is added to the diagnosis information DB 151 in accordance with the input of new report information by the user, on the basis of the added new radiological report information, the combination information composing the database belonging to the upper hierarchy Sa, the lower hierarchy Sb, and the bottom hierarchy Sc is enriched.

For instance, first, from the new radiological report information, the single-report structured data is generated by the function of the data assembling unit 113 described above. At this time, a process of structurization including a language process with the new radiological report information as the object is performed to provide each element composing the new radiological report information with information indicating the element item to which each element belongs as attribute information.

Then, this single-report structured data, i.e. the combination information is added to the database D0 belonging to the upper hierarchy Sa. That is, information (combination information) indicating a combination of the plurality of the elements composed of one or more elements associated with each item is added to the large amount of the combination information composing the database D0 to update the database D0.

Further, in accordance with the set stratification information, information (combination information) indicating a combination of the plurality of the elements composed of one or more elements associated with each item is appropriately added to the database belonging to the lower hierarchy Sb and the bottom hierarchy Sc. That is, the database belonging to the lower hierarchy Sb and the bottom hierarchy Sc is appropriately updated.

Here, for instance, with respect to the single-report structured data generated from the new radiological report information, the case where the attribute value of the attribute “inspection region” is “chest”, the attribute value of the attribute “modality” is “CR”, and the attribute value of the attribute “category” is “lung” will be described as an example.

In this case, in accordance with the set stratification information, the database (i.e. the database relating to the element combination “chest-CR”) D3 belonging to the lower hierarchy Sb, and the database (i.e. the database relating to the element “lung”) D3a belonging to the bottom hierarchy Sc are recognized as the object to which the information is added. Then, with respect to the database D3 and the database D3a, the entire or the portion of the combination information included in the new single-report structured data is added. In adding this information, of course, the common attribute value is shared.

<Report Input Function>

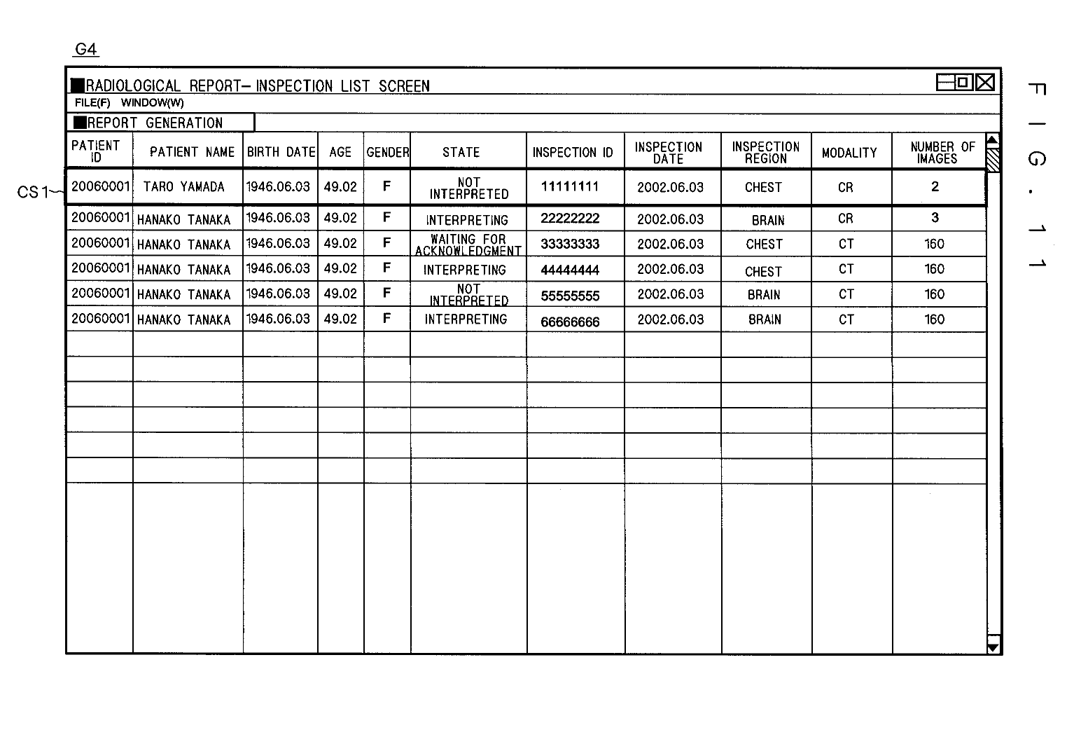

FIG. 11 is a view illustrating a screen (inspection list screen) G4 showing an inspection list. Here, when a button SB3 is pushed down in the main menu screen G1 shown in FIG. 8, inspection list information is read from the diagnosis information DB 151 by the data reading unit 111 to be transferred to the terminal 300, displaying the inspection list screen G4 in the display unit 330.

As shown in FIG. 11, the inspection list screen G4 is a screen on which information on the inspections (specifically, patient ID, patient name, birth date, age, gender, state, inspection ID, inspection date, inspection region, modality, and the number of images) is listed and displayed. This inspection list screen G1 indicates that the inspection denoted by a state “not radiographed” is an inspection in which a radiological report has not been created.

The inspection list screen G1 displays a bold cursor CS1 surrounding a single inspection. This bold cursor CS1 is moved above and below in response to the operation of the operation unit 340 by the user, and when the determination button (e.g. return key) of the operation unit 340 is pushed down in the state of pointing to a desired inspection, the single inspection surrounded by the bold cursor CS1 is specified as an input object inspection.

At this time, for instance, when the input object inspection is selected in the inspection list screen G4 as shown in FIG. 11, the combination of the element (e.g. chest) belonging to the item “inspection region” and the element (e.g. CR) belonging to the item “modality” is simultaneously specified and recognized. The element combination recognized here corresponds to the stratification information relating to the lower hierarchy Sb of the support information DB 152.

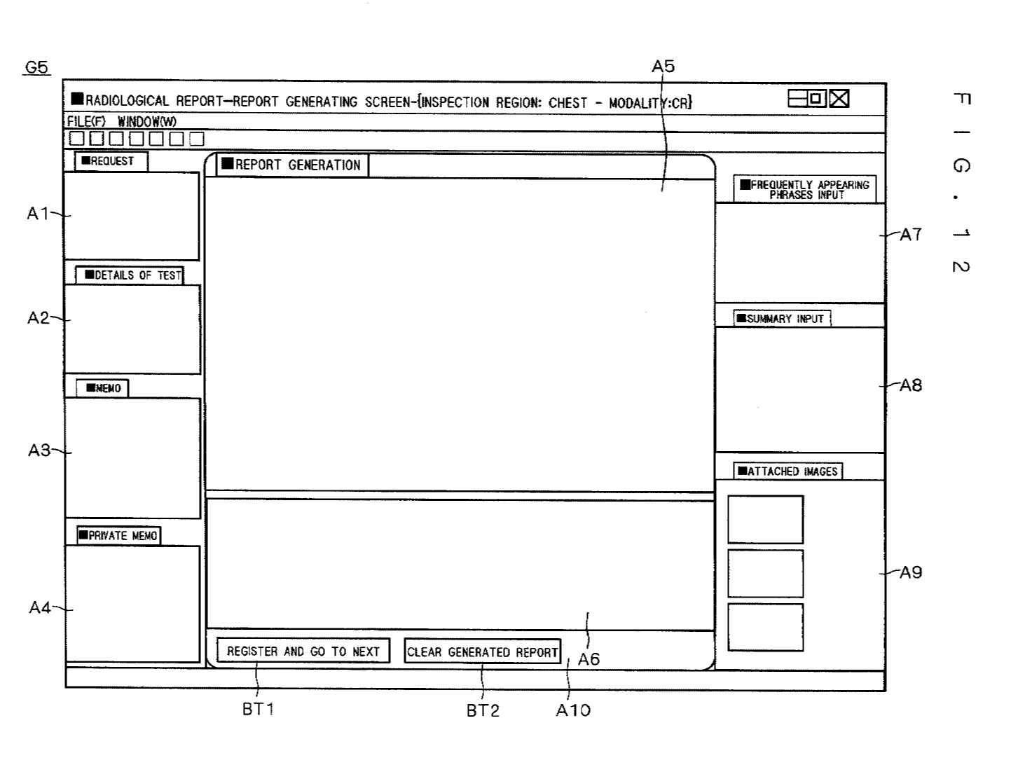

In this manner, when the input object inspection is specified, a screen displayed in the display unit 330 transits from the inspection list screen G4 to a report input screen G5 (FIG. 12).

When the input object inspection is specified, the task management unit 314 specifies a task relating to the creation of a new radiological report corresponding to the input object inspection. At this time, under the control of the task management unit 314, the request corresponding to the input object inspection and the attribute information showing the detail of the inspection are read by the data reading unit 111 from the diagnosis information DB 151, and provided to the control unit 310 of the terminal 300.

FIG. 12 is a view illustrating the report input screen G5 displayed in the display unit 330.

The report input screen G5 is composed of mainly areas A1 to A10.

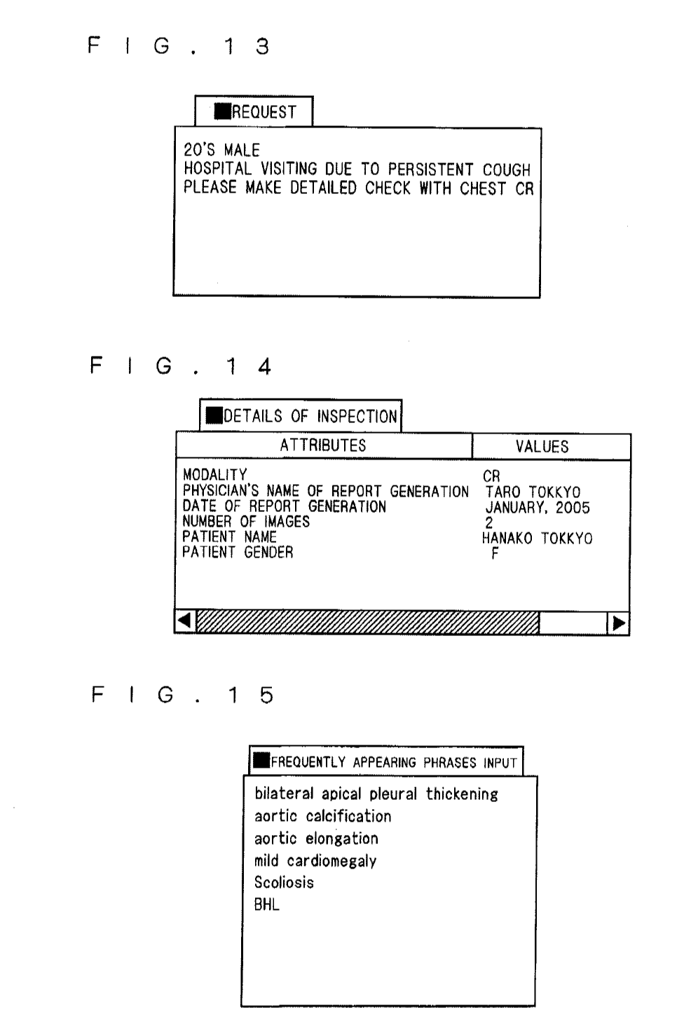

The area A1 is an area displaying the content of the request relating to the input object inspection, and for example, on the basis of the information relating to the request obtained from the diagnosis information DB 151 via the report server 100, the content of the request shown in FIG. 13 is displayed.

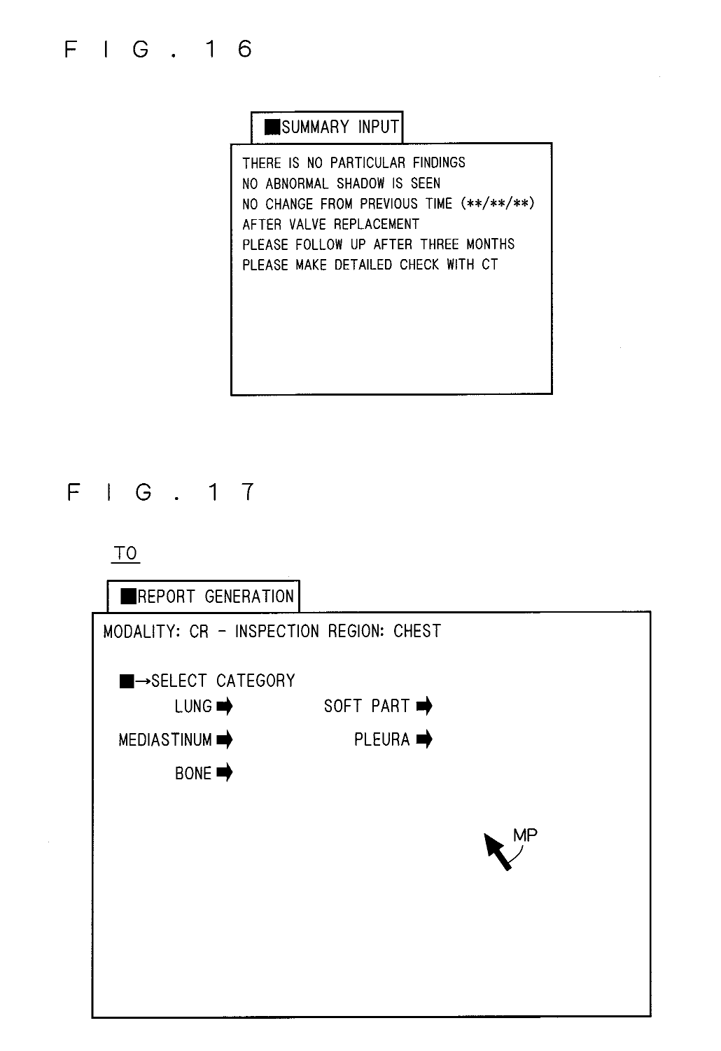

The area A2 is an area displaying the detail content of the inspection relating to the input object inspection, and for example, on the basis of the information relating to the detail of the inspection obtained from the diagnosis information DB 151 vie the report server 100, the detail content of the inspection shown in FIG. 14 is displayed.

The areas A3 and A4 are areas describing any notions and other information in accordance with the operation of the operation unit 340 by a radiologist.

The area A5 is an area visually providing the portion of information obtained from the support information DB 152 in order to support the creation of a radiological report.

The area A6 is an area displaying the remark composing the radiological report and in which the remark is described in response to the operation of the operation unit 340 by the radiologist.

The area A7 is an area displaying a list of typical phrases (frequently-appearing phrases) frequently used in the remark, and for example, a list of the frequently-appearing phrases as shown in FIG. 15 is displayed.

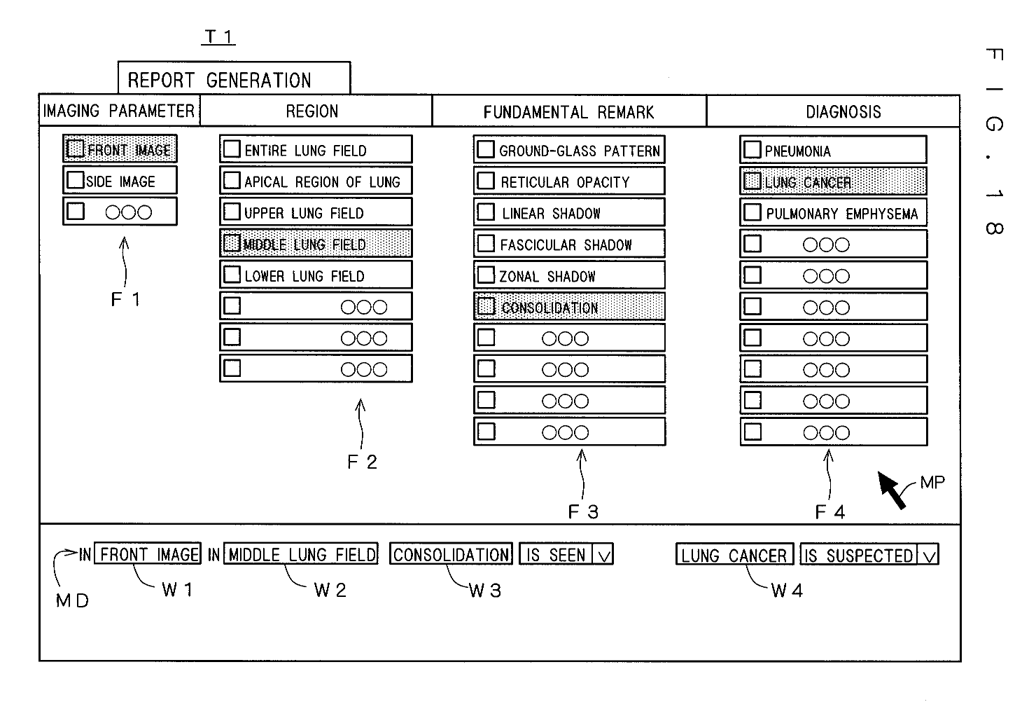

The area A8 is an area displaying a list of typical sentences (summary phrases) frequently used in the remark, and for example, a list of the typical sentences as shown in FIG. 16 is displayed.

The area A9 is an area attaching representative images, and desired representative images are attached in accordance with the operation of the operation unit 340 by the radiologist.

The area A10 is an area in which icons (here, buttons BT1 and BT2) for inputting a command are listed. Specifically, the button BT1 is a button confirming the content of the remark composing the radiological report generated in the report input screen G5 and the attached images to newly register in the diagnosis information DB 151, and inputting a command of transferring to generate a next radiological report. The button BT2 clears the content of the remark composing the radiological report generated in the report input screen G5 and the attached images, and inputting a command of recreating the content of the radiological report.

Next, the operation inputting the remark using a template displayed on the region A5 will be described.

In the area A5, information corresponding to the search rule inputted by the user is obtained from the support information DB 152, and appropriately visually outputted in the form of the template. Then, the input of the remark is performed by appropriately designating alternatives of the elements (here, words and/or phrases) in this template.

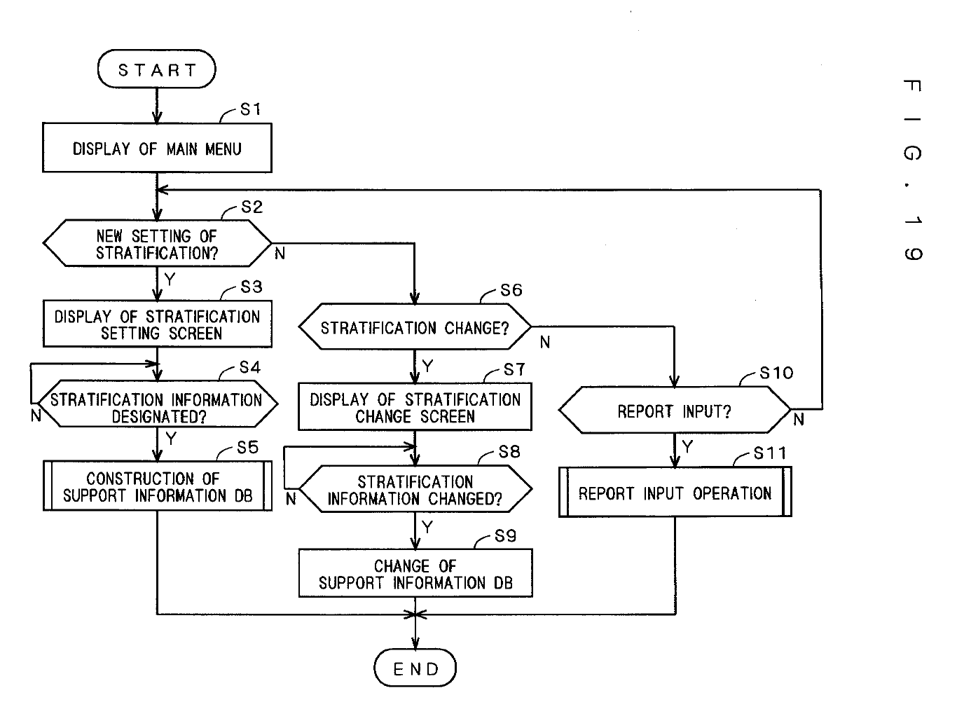

FIG. 17 is a view illustrating a template (extraction condition determination template) T0 determining the extraction condition for extracting a portion of the combination information from the support information DB 152.

In the extraction condition determination template T0, words and/or phrases (alternatives) are listed for a part of the attribute items (here, “category”) in all the attribute items in the support information DB 152. The alternatives relating to the attribute items “category” listed here correspond to the element defining the stratification information relating to the bottom hierarchy Sc of the support information DB 152.

In detail, the information search unit 114 recognizes the database corresponding to the information (combination information) indicating the element combination (here, the element combination defining the stratification information relating to the lower hierarchy Sb) recognized when the input object inspection is selected in the inspection list screen G4, in the database belonging to the lower hierarchy Sb. Then, the elements defining the stratification information relating to the database (here, the database belonging to the bottom hierarchy Sc) further depending on the recognized database are listed as the alternatives.

Specifically, in FIG. 17, when the combination of the elements “chest” and “CR” is selected in the inspection list screen G4 (e.g. FIG. 11), the extraction condition determination template T0 displayed in accordance with the support information DB 152 shown in FIG. 7 is shown. For instance, among the databases D1a to D1d, D2a to D2k, and D3a to D3e belonging to the bottom hierarchy Sc, the elements “lung”, “mediastinum”, “bone”, “soft part”, and “pleura” relating to the databases D3a to D3e further depending on the database D3 relating to the element combination “chest-CR” belonging to the lower hierarchy Sb are listed as the alternatives.

In this extraction condition determination template T0, when the radiologist points the mouse pointer MP to a desired alternative and performs a predetermined operation (e.g. double-click of a mouse) by operating the operation unit 340 in various ways, the alternatives belonging to the item “category” is designated. Here, the element combination selected in the inspection list screen G4 and the extraction condition determination template T0 is designated as the extraction condition.

For instance, in the extraction condition determination template T0 shown in FIG. 17, when the alternative “lung” belonging to the item “category” is designated, the three element combinations of the element “chest” of the item “inspection region”, the element “CR” of the item “modality”, and the element “lung” of the item “category” are designated as the extraction condition. That is, this extraction condition is to include information specifying the database belonging to the bottom hierarchy Sb.

The search control unit 316 generates the search rule including the extraction condition to transmit to the information search unit 114 via the input/output control unit 313.

The information search unit 114 extracts a portion of the combination information corresponding to the extraction condition included in the search rule from the support information DB 152 in response to the input of the search rule. At this time, the database to be the object of the search for extracting a portion of the combination information is narrowed down in accordance with the information specifying the database belonging to the bottom hierarchy Sb included in the extraction condition.

For instance, when the extraction condition is the element combination composed of the element “chest” of the item “inspection region”, the element “CR” of the item “modality”, and the element “lung” of the item “category”, the database to be the object of the search is limited to the database D3a belonging to the bottom hierarchy Sc in the support information DB 152. Here, since the extraction condition only includes information specifying the database belonging to the bottom hierarchy Sc, the entire combination information composting one database belonging to the bottom hierarchy Sc is extracted.

The extraction condition may include information specifying the combination of one element (e.g. word and/or phrase) or two or more elements (e.g. word and/or phrase) as information narrowing down the extracted information (narrowing down information) in response to the input by the user, in addition to the information specifying the database. In this case, the element (here, the combination information) included in each single-report structured data corresponding to the narrowing down information is extracted from the database corresponding to the information specifying the database.

The information search unit 114 generates the result display screen data in accordance with a screen generating rule corresponding to the search rule, on the basis of the extracted information to transfer to the control unit 310 of the terminal 300.

In the terminal 300, on the basis of the result display screen data, a list (list display) of the information, in which one or more elements are associated with each item, is visually outputted in the display unit 330 by the control of the display control unit 315. That is, on the basis of the information extracted by the information search unit 114, the list display is visually outputted in the display unit 330. Specifically, a template (hereinafter, also referred to as an “input support template”) supporting the input of the remark of the new radiological report is displayed in the display unit 330.

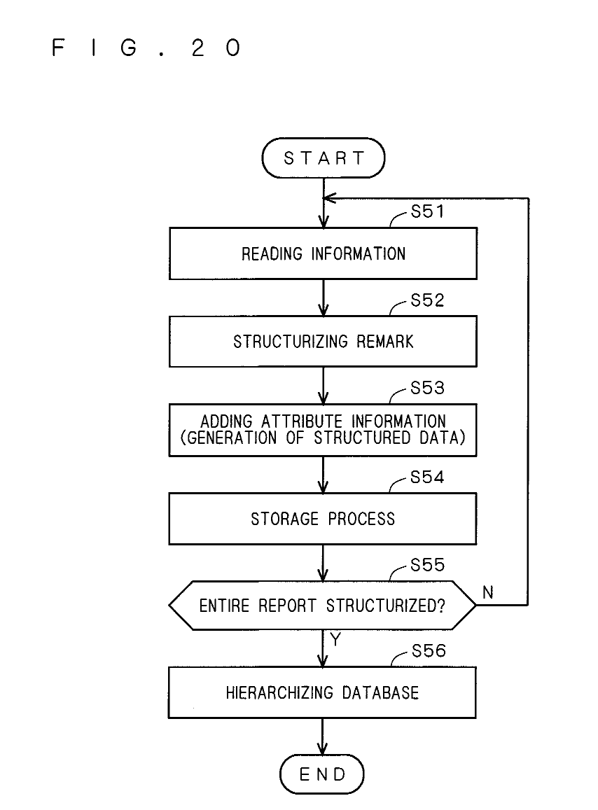

FIG. 18 is a view illustrating a display example of an input support template T1. Various inputs and designation in the input support template T1 described later are conducted on the basis of the signal inputted in response to the operation of the operation unit 32 by the radiologist.

As shown in FIG. 18, in the input support template T1, in a region of approximately three-quarters from the above, each of the plurality of the elements (here, words and/or phrases) F1 to F4 on the items “imaging parameter”, “region”, “fundamental remark”, and “diagnosis” is displayed in order from the left.

In more detail, in the input support template T1, a plurality of words and/or phrases (“front image”, “side image” and the like) F1 are listed for the attribute item “imaging parameter”, a plurality of words and/or phrases (“entire lung field”, “apical region of lung”, and the like) F2 are for the attribute item “region”, a plurality of words and/or phrases (“ground-glass pattern”, “reticular opacity” and the like) F3 are for the attribute item “fundamental remark”, and a plurality of words and/or phrases (“pneumonia”, “lung cancer” and the like) F4 are for the attribute item “diagnosis”.

The plurality of the elements listed in the input support template T1 are listed by arranging the display elements indicating one or more elements (here, words and/or phrases) belonging to each item included in the plurality of items (here, four items “imaging parameter”, “region”, “fundamental remark”, and “disease name”) in order in a space. For instance, as shown in FIG. 18, the display elements indicating one or more words and/or phrases are listed in the state where the relationship with the display element indicating the corresponding item is visually recognizable, such as being listed under the display element indicating the item on which the one or more words and/or phrases depend. Specifically, for example, the display elements “front image”, “side image”, and the like indicating the words and/or phrases are arranged and displayed along a vertical direction below the display element indicating the item “imaging parameter” on which the words and/or phrases depend.

In the input support template T1, the word and/or phrase corresponding to each item composing the remark of the new radiological report is designated for each item of the four items “imaging parameter”, “region”, “fundamental remark”, and “diagnosis” by pointing the mouse pointer MP to at least one word and/or phrase from the plurality of the words and/or phrases and left-clicking.

The radiologist as the user refers to a sentence model MD of a remark on a radiological report displayed below the input support template T1 when the word and/or phrase corresponding to each item is designated. The information relating to this sentence model MD is, for example, provided from the outside in addition to the teaching data and the like. This sentence model MD shows a model of the remark on the radiological report, such as “In [blank column W1], in [blank column W2], [blank column W3] is seen and [blank column W4] is suspected.”

Then, the words and/or phrases as the elements (element composing a sentence, hereinafter, also referred to as a “sentence composing element”) relating to the four items “imaging parameter”, “region”, “fundamental remark”, and “diagnosis” are applied to the blank columns W1 to W4, respectively. In other words, the radiologist as the user designates the words and/or phrases to fill the blank column W1 with at least one word and/or phrase (e.g. “front image”) in the plurality of the words and/or phrases (alternatives) F1, and to fill the blank column W2 with at least one word or phrase (e.g. “middle lung field”) in the plurality of the words and/or phrases (alternatives) F2. Further, at least one word or phrase (e.g. “consolidation”) in the plurality of the words and/or phrases (alternatives) F3 is filled in the blank column W3, and at least one word or phrase (e.g. “lung cancer”) in the plurality of the words and/or phrases (alternatives) F4 is filled in the blank column W4. Any word or phrase is filled in the blank columns W1 to W4 by operating a keyboard and the like of the operation unit 340 in various ways by the user.

In FIG. 18, the four of words and phrases “front image”, “middle lung field”, “consolidation”, and “lung cancer” are designated for the four items “imaging parameter”, “region”, “fundamental remark”, and “diagnosis”, respectively, being shown in the state shading of the display element indicating the designated word and/or phrase is inverted.

In the above input support template T1, as described above, the operation unit 340 is appropriately operated in the state where the words and/or phrases designated for each of the four items are filled in the blank columns W1 to W4 of the sentence model MD, and the button BT1 is pushed down with the mouse pointer MP, so that the words and/or phrases filled in the blank columns W1 to W4 of the sentence model MD are inputted by the report generating unit 317 as sentence composing elements relating to each item in accordance with a predetermined sentence model MD.

Then, a new remark is generated by the report generating unit 317 on the basis of the sentence model MD and the sentence composing elements designated to each item, and the remark is displayed in the region A5.

At this time, the information of the remark newly generated is added and registered in the diagnosis information DB 151 by the data writing unit 115. For instance, the information indicating the remark composed of a natural sentence such as “In a front image, in a middle lung field, consolidation is seen and lung cancer is suspected” is generated to be added and registered in the diagnosis information DB 151. That is, on the basis of the sentence composing element belonging to each item, information (new radiological report information) of a new radiological report including a new remark in accordance with a predetermined sentence model MD is generated and this new radiological report information is accepted by the storage unit 150 to be added and registered in the diagnosis information DB 151.

The new radiological report information is information corresponding to the element combination composed of each single element belonging to each item, respectively, included in the plurality of the items of the elements, and information (input information) inputted in accordance with the input operation by the user.

In FIG. 18, the example designating a single sentence composing element to each item is given, but being not limited to this, for example, at least one or more sentence composing elements may be designated, such that two or more sentence composing elements are designated for each item.

In this manner, in the input support template T1, when at least one element is designated for each item in response to the input by the user, the element composing a new remark in accordance with a predetermined sentence model MD is inputted. Thus, the plurality of the elements composing the report information are easily inputted. Further, at this time, the new radiological report information including the new remark in accordance with the predetermined sentence model MD is generated to be added and registered in the diagnosis information DB 151, allowing to easily generate the information (report information) indicating a report. That is, the report is easily generated.

<Operation Flow of Information Process System>

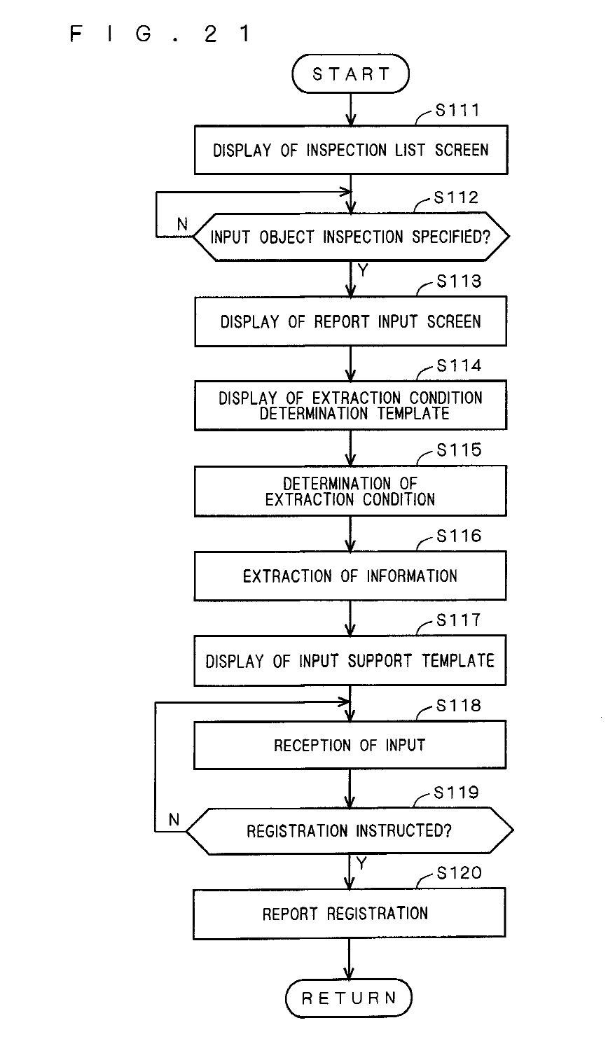

FIGS. 19 to 22 are flow charts showing an operation flow of the information process system 1. The user operates the operation unit 340 in various ways and the program Pgb is executed in the control unit 310 to start the operation flow.

In a step S1, the main menu screen G1 (FIG. 8) is displayed in the display unit 330 by the control of the control unit 310.

In a step S2, whether the hierarchical structure of the support information DB 152 is newly set or not is determined by the control of the control unit 310. Here, when the button SB1 of the main menu screen G1 is pushed down to select the function of “new setting of stratification”, it proceeds to a step S3, and when the button SB1 is not pushed down, it proceeds to a step S6.

In the step S3, the stratification setting screen G2 (FIG. 9) is displayed in the display unit 330 by the control of the control unit 310.

In a step S4, whether the stratification information is designated or not is determined by the control of the control unit 310. In this step S4, when the determination button DB2 is pushed down with the mouse pointer MP in the state where the element combination and the element defining desired stratification information are described in the columns L21 and L22 in the stratification setting screen G2, it determines that the stratification information is designated and proceeds to a step S5. At this time, the stratification information is set by the stratification setting unit 312 to store in a predetermined storage unit (e.g. storage unit 150). In the step S4, the determination of the step S4 is repeated until the stratification information is designated.

In the step S5, the support information DB 152 is constructed. In this step S5, the operation flow shown in FIG. 20 is performed, and this operation flow is terminated. The detail of the operation flow in the step S5 will be described later.

In a step S6, whether the hierarchical structure of the support information DB 152 is changed or not is determined by the control of the control unit 310. Here, when the button SB2 of the main menu screen G1 is pushed down to select the function of “stratification change”, it proceeds to a step S7, and when the button SB2 is not pushed down, it proceeds to a step S10.

In the step S7, the stratification change screen G3 (FIG. 10) is displayed in the display unit 330 by the control of the control unit 310.

In a step S8, whether there is an instruction to change the setting of the stratification information or not is determined by the control of the control unit 310. In this step S8, when the element combination and the elements are deleted or added to the columns L21 and L22 in the stratification change screen G3, and the determination button DB 2 is pushed down with the mouse pointer MP, it determines that there is the instruction to change the setting of the stratification information and proceeds to a step S9. At this time, the setting of the stratification information is changed by the stratification setting unit 312, and the setting of the stratification information having been changed is stored in a storage unit (e.g. storage unit 150). In the step S8, the determination of the step S8 is repeated until there is the instruction to change the setting of the stratification information.

In the step S9, the support information DB 152 is changed in accordance with the stratification information whose setting is changed by the stratification setting unit 312, and this operation flow is terminated. In this step S9, when a new element combination and a new element are added to the element combination and the element defining the stratification information due to the change of the setting of the stratification information, the database corresponding to the added element combination and element is generated by the similar operation as the generation of the database belonging to the lower hierarchy Sb and the bottom hierarchy Sc described above to be appropriately added to the support information DB 152. On the other hand, when a portion of the element combination and the element defining the stratification information is deleted due to the change of the setting of the stratification information, the database corresponding to the deleted element combination and element is removed from the support information DB 152.

In the step S10, whether a radiological report is inputted or not is determined by the control of the control unit 310. Here, when the button SB3 of the main menu screen G1 is pushed down to select the function of “report input”, it proceeds to a step S11, and when the button SB3 is not pushed down, it returns to the step S2. That is, the determinations of the steps S2, S6, and S10 are repeated until the buttons SB1 to SB3 of the main menu screen G1 are pushed down.

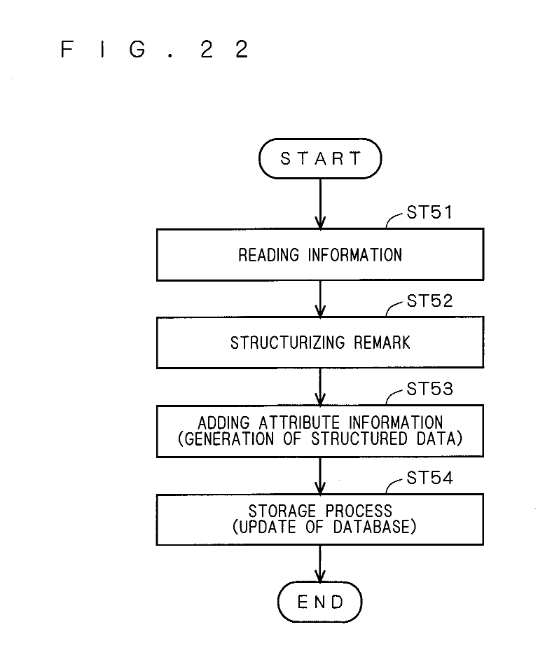

In the step S11, the operation of the report input function is performed in cooperation with the control units 110 and 310. In this step S11, an operation flow shown in FIG. 21 is performed, and this operation flow is terminated. The operation flow in the step S11 will be described later in detail.

Here, the detail of the operation flow on the construction of the support information DB 152 in the above step S5 will be described. FIG. 20 is a flow chart showing an operation flow constructing the support information DB 152.

In a step S51, a single piece of radiological report information is read into from the diagnosis information DB 151 with the attribute information by the data reading unit 111.

In a step S52, the radiological report information read in the step S51 is structured by the data assembling unite 113.

In a step S53, the attribute information is added to the radiological information structured in the step S52 to generate the single-report structured data as shown in FIG. 3 by the data assembling unit 113.

In a step S54, a process (storage process) in which the single-report structured data generated in the step S53 is performed by the data assembling unit 113. In the second time or later of this storage process, with respect to a predetermined attribute in the plurality of the single-report structured data, a common attribute value is shared.

In a step S55, whether single-report structured information is generated or not for the entire generated radiological report information stored in the diagnosis information DB 151 is determined by the inspected determination unit 112. In this step S55, when the single-report structured information is not generated for the entire generated radiological report information, it returns to the step S51, and information indicating a next radiological report is read to generate single-report structured information and accumulate it in the storage unit 150. By accumulating such a large amount of single-report structured information, the database D0 belonging to the upper hierarchy Sa is assembled in the storage unit 150. On the other hand, when the single-report structured information is generated for the entire generated radiological information, it proceeds to a step S56.

In the step S56, a hierarchical database, i.e. the support information DB 152 is constructed in accordance with the set stratification information by the data assembling unit 113, and this operation flow is terminated. In this step S56, in accordance with the stratification information, the database belonging to the lower hierarchy Sb is generated by extracting a portion of the combination information from the database belonging to the upper hierarchy Sa. Further, in accordance with the stratification information, the database belonging to the bottom hierarchy Sc is generated by extracting a portion of the combination information composing the database belonging to the lower hierarchy Sb.

Next, an operation flow of the report input function in the above step S11 will be described in detail. FIG. 21 is a flow chart showing the operation flow of the report input function.

In a step S111, an inspection list screen G4 as shown in FIG. 11 is displayed in the display unit 330 by the control of the display control unit 315. Here, inspection list information is read from the diagnosis information DB 151 by the data reading unit 111 to transfer to the display control unit 315.

In a step S112, whether an inspection (input object inspection) to be an object of inputting radiological report information is selected in the inspection list screen G4 or not is determined by the task management unit 314. Here, the determination of the step S112 is repeated until the input object inspection is selected, and when the input object inspection is selected, it proceeds to a step S113.

In the step S113, the report input screen G5 as shown in FIG. 12 is displayed in the display unit 330 under the control of the control unit 310.

In a step S114, the extraction condition determination template T0 as shown in FIG. 17 is displayed in the region A5 of the report input screen G5 mainly by the information search unit 114 and the display control unit 315.

In a step S115, the extraction condition is determined by the search control unit 316 in response to the designation of the alternatives on the extraction condition determination template T0. This extraction condition includes, for example, information specifying the database of the lower hierarchy Sb in the support information DB 152 such as an inspection region and a category, and further includes information specifying the database of the bottom hierarchy Sc. Here, the search rule including the extraction condition is generated by the search control unit 316 to send out to the information search unit 114.

In a step S116, a portion of the information corresponding to the extraction condition determined in the step S115 is extracted from the support information DB 152 by the information search unit 114. Here, the database to be an object of the search for extracting a portion of the information is narrowed down by the information specifying the database belonging to the bottom hierarchy Sb included in the extraction condition. The result display screen data based on the extracted portion of the information is generated and transmitted to the control unit 310.

In a step S117, the input support template T1 based on the portion of the information (specifically, result display screen data) extracted in the step S116 is displayed in the region A5 of the report input screen G5 by the control of the display control unit 315.

In a step S118, the input from the operation unit 340 by the user is received in the reception unit 311 to perform various inputs in the input support templates T1. At this time, the remark in accordance with the designation of the words and/or phrases in the input support template T1 is presented to the region A6.

In a step S119, whether there is an instruction of registering radiological report information or not is determined by the reception unit 311. Here, various inputs in the input support template T1 are received until the button BT1 is pushed down in the input support template T1 to instruct to register the radiological report information (step S118), and when the registration of the radiological report information is instructed, it proceeds to a step S120.

In the step S120, information indicating new radiological report information including the remark in accordance with the input in the step S118 is generated by the report generating unit 317, and new radiological report information is registered in the diagnosis information DB 151 by the data writing unit 115.

Here, after the process of the step S120 is terminated, it returns to the step S111 so as to input radiological report information relating to a next inspection. During the processes of the steps S111 to S120, for example, when a specific operation is performed to the operation unit 340 by the user, the operation flows shown in FIG. 19 to FIG. 21 are terminated.

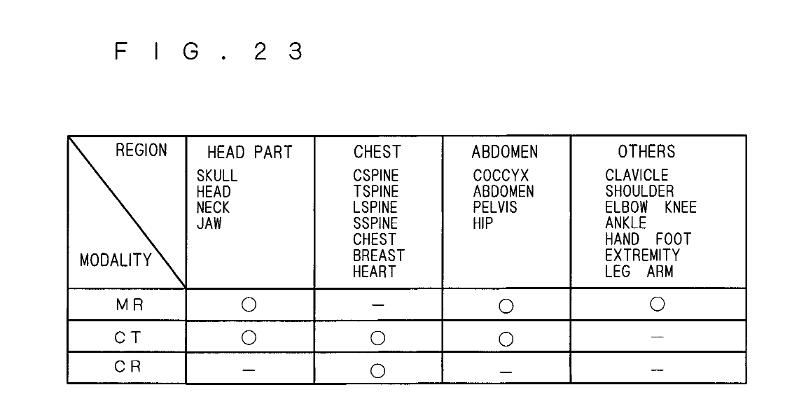

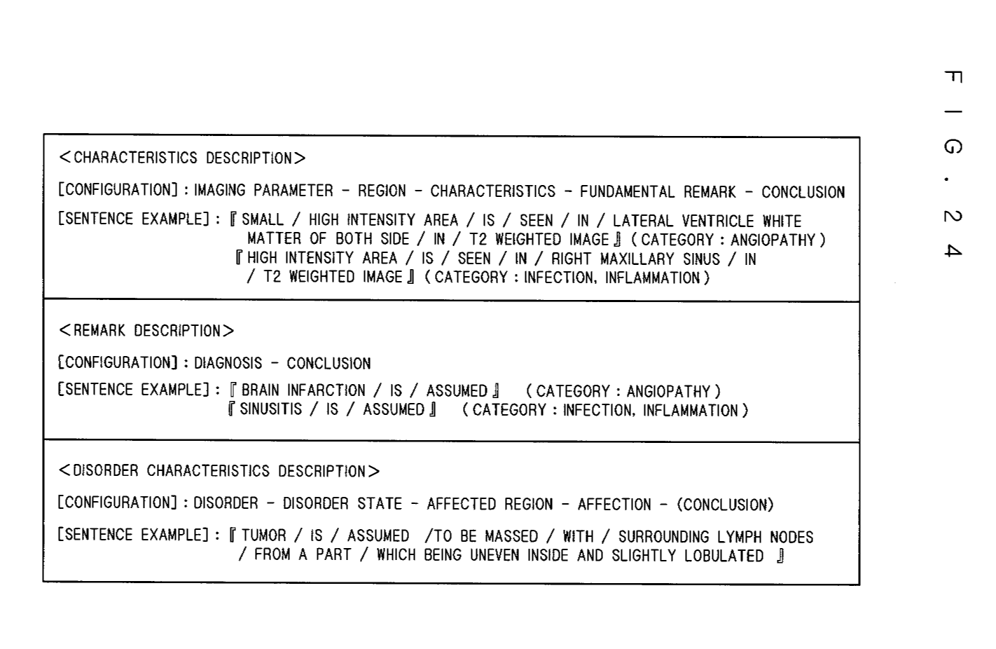

When new radiological report information is added to the diagnosis information DB 151 by the operation flow shown in FIG. 21, on the basis of the added new radiological report information, the combination information composing the database belonging to the upper hierarchy Sa, the lower hierarchy Sb, and the bottom hierarchy Sc is enriched. FIG. 22 is a flow chart showing the operation flow when the combination information is enriched.

In a step ST51, the new radiological report information is read together with the attribute information from the diagnosis information DB 151 by the data reading unit 111.

In a step ST52, the new radiological report information read in the step ST51 is structured by the data assembling unit 113.

In a step ST53, the attribute information is added to the radiological report structured in the step ST52 by the data assembling unit 113, and the single-report structured data as shown in FIG. 3 is generated.

In a step ST54, a process (storage process) adding the single-report structured data generated in the step ST53 to the support information DB 152 is performed. That is, the support information DB 152 is updated.

In this step ST54, first, the single-report structured data newly generated in the step ST53, i.e. the combination information is added to the database D0 belonging to the upper hierarchy Sa to update the database D0. Further, in accordance with the set stratification information, all or a portion of the combination information included in the single-report structured data newly generated in the step ST53 is/are added to the database belonging to the lower hierarchy Sb and the bottom hierarchy Sc. After the process of this step ST54 is terminated, the operation flow when the combination information is enriched is terminated.

However, the process updating a plurality of the databases requires the operation amount relating to data processing to some extent, i.e. the time required for the data processing. Therefore, the combination information in the support information DB 152 may be enriched as a whole at a predetermined timing, or may be enriched at the appropriate times in a background of the operation relating to the report input function. The predetermined timing includes, for example, timing when the operation relating to the report input function is not performed in the report server 100 as much as possible, such as during the night.

As in the above, in the information process system 1 according to the preferred embodiment of the present invention, the support information DB 152 has the form of a hierarchical database. Further, information specifying a comparatively lower database is included in the extraction condition. This information specifying the database narrows down the database to be a search object when a portion of the information corresponding to the extraction condition is searched from the support information DB 152. That is, the data amount of the search object is reduced. Therefore, the operation amount required for the process extracting a portion of the information from the database is reduced. Thus, the time required for the process extracting a portion of the information from the database including a large amount of information indicating each element combination is shortened.

Further, at this time, a portion of the information narrowed down in the support information DB 152 is extracted and visually presented. Therefore, the visibility of a screen displaying the search result is improved.

Here, assuming that the database is generated by simply dividing into small pieces in terms of reducing the process time and improving the visibility of the screen, the database should be stratified into extremely small pieces from various perspectives. However, such stratification needs a complicated work, which is not effective. If the stratification method is to be changed, the database should be regenerated from the start, which is not effective.

In contrast, in the information process system 1 according to the preferred embodiment of the present invention, the support information DB 152 is not to be an aggregate of a plurality of databases simply stratified, but to have the form of a hierarchical database. Therefore, when the setting of the stratification information relating to a relatively lower database is changed, a portion of the combination information composing a relatively upper database is extracted and the relatively lower database corresponding to the setting of new stratification information is assembled. Thus, in particular, when the stratification method of the lower database is changed, the user easily stratifies the database with a desired concept. That is, the fragmented database is efficiently assembled, and it may be said that the flexibility in the stratification of the database is high.

In accordance with the input of new report information, the contents of the database belonging to the upper hierarchy Sa, lower hierarchy Sb, and the bottom hierarchy Sc in the support information DB 152 are developed. Therefore, in accordance with the input of new knowledge, both of the upper and lower databases in the support information DB 152 are easily developed. In this manner, not only the lower database is updated, but the upper database is updated. Thus, when the stratification method of the lower database is changed, the database is easily stratified at a desired section, reflecting the contents developed with the time.

Also, the data contents composing the database are easily described by employing the configuration describing the combination information composing the support information DB 152 in the RDF.

<Modifications>

The present invention is not limited to the above preferred embodiment, but various variations and modifications are possible without departing from the scope of the invention.

For instance, in the above preferred embodiment, the support information DB 152 has the form of the hierarchical database composed of three hierarchies such as the upper hierarchy Sa, the lower hierarchy Sb, and the bottom hierarchy Sc, but the invention is not limited to this. For instance, it may have the form of a hierarchical database composed of two or more hierarchies such as two hierarchies.

In the above preferred embodiment, when new report information is inputted, single-report structured data is generated and added to the support information DB 152 to update the database included in the support information DB 152, but the invention is not limited to this. For instance, when a sentence composing element on each item along a predetermined sentence model MD is inputted in the input support template T1 in response to the input of the user, information indicating a combination of the plurality of the elements composed of one or more elements associated with each item, i.e. new combination information is regarded to be inputted. Thus, the database included in the support information DB 152 may be directly updated on the basis of the new inputted combination information, without generating new report information.

In detail, the combination information indicating the plurality of the elements composed of one or more elements associated with each item may be added to each of the upper hierarchy Sa, the lower hierarchy Sb, and the bottom hierarchy Sc included in the support information DB 152 on the basis of this new inputted combination information and the stratification information. In this configuration, the attribute information relating to the input object inspection may be appropriately included in the combination information.

In the above preferred embodiment, the database is hierarchized with an inspection region, modality, and category as a reference, but the invention is not limited to this. For instance, the database may be hierarchized with information (genetic information) relating to gender, age, and genetic elements, and attribute (patient attribute) depending on an individual patient such as the environment, as a reference. These various settings of stratification allows to extract a portion of the information for various extraction conditions and to present the extraction result in a short time.

In the above preferred embodiment, a portion of the information is extracted from the bottom hierarchy Sc, but the invention is not limited to this, and when a portion of the information corresponding to the extraction condition extends to several databases belonging to the bottom hierarchy Sc, a portion of the information may be extracted from the database belonging to the upper hierarchy Sa (or the lower hierarchy Sb). The cases of the extraction in this manner includes, for example, the case where the extraction condition includes an element belonging to several categories.

With respect to the plurality of the databases belonging to the bottom hierarchy Sc, the data contents overlapping to each other may exist, and a certain database may be composed of the plurality of the combination information included in the plurality of the databases. For instance, when new stratification information is added, a certain database is composed of the plurality of the combination information included in the plurality of the databases in the plurality of the databases classified into each category and the plurality of the databases classified into age and gender. When it is stratified by gender, for instance, when a patient is male, the content of the input support template is more limited to necessary items by not including genecology-related elements in the information extracted from the support information DB 152 in accordance with the extraction condition, allowing the input of a radiological report to be further easier.

In the above preferred embodiment, the combination information composing the database belonging to the upper hierarchy Sa is information relating to a specific region and a specific modality, but the invention is not limited to this. For instance, the database belonging to at least one of the upper hierarchy Sa, the lower hierarchy Sb, and the bottom hierarchy Sc may be composed by accumulating the plurality of the combination information including at least one of the specific inspection region and the specific modality.

In the above preferred embodiment, the large amount of the radiological report information is accumulated in the diagnosis information DB 151 and the large amount of the combination information composing the support information DB 152 is information indicating the plurality of the element combination composing a radiological report, but the invention is not limited to this. For instance, information relating to other medical care such as a nursing report may be accumulated in the diagnosis information DB 151, and the combination information composing the support information DB 152 may be information indicating the plurality of the element combination relating to medical care. That is, for example, the present invention is applicable to a system creating a document for other medical care such as a nursing report, an incident report, and the like.

Further, for instance, the present invention is applicable to the creation of a report in the field other than medical care, such as a business report, and the present invention is applied to the field other than a report. Particularly, it is effective to apply the present invention in the field where knowledge is accumulated as time passes, making use of the past experiences.

For instance, the present invention is applicable to the field applying a system in which the relationship of the elements belonging to items relating to occurrence of the accident (e.g. “cause”, “result”, “countermeasure”, and “preventive measure”) is recognized so as to analyze and prevent the accident. Also, the present invention is applicable to the field applying a system in which the relationship of the elements belonging to items relating to business fluctuation (e.g. “stock price movements of electricity industry”, “stock price movements of auto industry”, and the like) is recognized so as to predict the business fluctuation.

1. An information process system, comprising:
a first database in which a large amount of combination information indicating combinations of a plurality of elements composed of one or more elements associated with each item, is accumulated;
a second database in which a portion of the combination information included in said first database is accumulated;
an extracting unit extracting information corresponding to an extraction condition including information specifying said second database from said second database in accordance with designation of the extraction condition by a user; and
an output unit visually outputting a list of information in which one or more elements are associated with each item, on the basis of information extracted by said extracting unit.

2. The information process system according to claim 1, further comprising,
an assembling unit extracting a portion of the combination information from said first database in accordance with the input by the user, and assembling a third database storing the portion of the combination information.

3. The information process system according to claim 1, further comprising:
a reception unit receiving input information indicating a combination of a plurality of elements composed of one or more elements associated with each item, in response to the input by the user; and
an update unit updating said first and second databases by adding the combination information indicating the combination of the plurality of the elements composed of one or more elements associated with each item, to each of said first and second databases, on the basis of said input information.

4. The information process system according to claim 3, further comprising:
an acquiring unit acquiring report information in accordance with the input by the user; and
a generating unit generating said input information by performing a predetermined information process including a language process with said report information as an object to recognize a plurality of elements composing the report information, and by associating information indicating items to which each element belongs, with each element composing the report information to combine the plurality of elements composing the report information.

5. The information process system according to claim 1, further comprising:
a designating unit designating at least one element to each item in accordance with the input by the user in the list of said information; and
a generating unit generating report information in accordance with a predetermined model on the basis of a plurality of elements designated by said designating unit.

6. The information process system according to claim 1,
wherein said combination information includes information described in a RDF.

7. The information process system according to claim 1, further comprising:
a storage unit storing a plurality of report information; and
an assembling unit assembling said first database by performing a predetermined information process including a language process with each of said report information as an object to recognize a plurality of elements composing each of said report information, and by associating information indicating items to which each element belongs, with each element composing each of said report information to combine the plurality of elements composing each of said report information.

8. The information process system according to claim 1,
wherein said combination information includes information indicating a combination of a plurality of the elements relating to medical care.

9. The information process system according to claim 8,
wherein said plurality of the elements relating to medical care includes a plurality of elements composing a radiological report.

10. The information process system according to claim 9,
wherein at least either one of said first and second databases accumulates the plurality of combination information including one or more elements indicating at least either one of a specific region and a specific modality.

11. (canceled)

12. A computer software program including a recording medium that records a computer-readable software program, the software program for controlling a computer to operate as a database system, the database system comprising:
a first database in which a large amount of combination information indicating combinations of a plurality of elements composed of one or more elements associated with each item, is accumulated;
a second database in which a portion of the combination information included in said first database is accumulated;
an extracting unit extracting information corresponding to an extraction condition including information specifying said second database from said second database in accordance with designation of the extraction condition by a user; and
an output unit visually outputting a list of information in which one or more elements are associated with each item, on the basis of information extracted by said extracting unit.
